(19) United States
(12) Patent Application Publication
(10) Pub. No.: US 2024/0326475 A1
(43) Pub. Date: Oct. 3, 2024

(54) PRINTING DEVICE, COLOR MEASUREMENT POSITION DETECTION METHOD, AND NON-TRANSITORY COMPUTER-READABLE RECORDING MEDIUM CONTAINING COLOR MEASUREMENT POSITION DETECTION PROGRAM

(71) Applicant: SCREEN Holdings Co., Ltd., Kyoto (JP)

(72) Inventors: Shigenori ARIZONO, Kyoto (JP); Yuya TAKAGI, Kyoto (JP); Muneaki KITAOJI, Kyoto (JP); Kenichi YOKOUCHI, Kyoto (JP)

(21) Appl. No.: 18/615,622

(22) Filed: Mar. 25, 2024

(30) Foreign Application Priority Data
Mar. 28, 2023 (JP) 2023-050870

(51) Int. Cl. B41J 11/00; B41J 2/165; B41J 2/21; G06K 15/02; G06K 15/10

(52) U.S. Cl. CPC B41J 11/0095; B41J 2/16517; B41J 2/2135; B41J 2/2142; B41J 11/008; G06K 15/027; G06K 15/102; G06K 2215/101

(57) ABSTRACT

In a printing device, a measurement position detection chart including a reference pattern and a detection pattern is printed on printing paper. A colorimeter performs color measurements on the chart. The reference pattern has a sufficient dimension in a paper width direction to cover the range of a color chart in the same direction. The detection pattern includes multiple rectangular patches arranged in a conveyance direction while deviating from one another in the paper width direction. The color measurements result in colorimetric data, containing detection pattern density values Dp1 to Dpn, which is used to identify, as a current measurement position qc, a position of a patch in the paper width direction corresponding to a density value Dpk generally equal to a reference density value Drf among the detection pattern density values Dp1 to Dpn.

### CROSS-REFERENCE TO RELATED APPLICATIONS

The present application claims priority from Japanese Patent Application No. 2023-050870 filed on Mar. 28, 2023, the entire contents of which are hereby incorporated by reference.

### BACKGROUND OF THE INVENTION

### Field of the Invention

The present invention relates to printing devices, more specifically to detecting a measurement position for reading a color chart recorded on a printing medium for color adjustments to printed images.

### Description of the Related Art

In a typical inkjet printing device used for color image printing, an ink-discharge head (printhead) with numerous ink-discharge nozzles is provided for each of four process colors (C: cyan, M: magenta, Y: yellow, and K: black). These nozzles discharge ink onto a printing medium, such as printing paper, using heat or pressure for color image printing.

In the inkjet printing device as described above, color adjustments are made based on colorimetric data or values obtained by performing color measurements on a color chart consisting of patches in various colors. In this regard, when the inkjet printing device includes a colorimeter (specifically, an inline colorimeter), the colorimeter performs color measurements on a color chart recorded on a printing medium by the printheads discharging ink on the printing medium. At this time, accurate colorimetric data is not obtained unless the color chart on the printing medium and the colorimeter that performs color measurements on the color chart align in a proper positional relationship. Accordingly, the position of the colorimeter is adjusted, for example, either immediately after the colorimeter is installed in the inkjet printing device or immediately after replacing the printing medium.

It should be noted that in relevance to the present invention, Japanese Laid-Open Patent Publication No. 2013-111777 discloses highly accurate conveyance error detection technology for proper color measurements on colorimetric charts (color charts for colorimetry). This technology acquires a conveyance error amount based on peak values obtained by performing color measurements on a conveyance confirmation chart as shown in FIG. 34, and adjusts the position of the printing medium upon color measurements on the colorimetric chart based on the acquired conveyance error amount.

Nevertheless, the printing medium might be displaced in a direction perpendicular to the direction in which the printing medium is conveyed (simply referred to below as the “conveyance direction”) due to the execution of printing under various printing settings or changes in conditions of the conveyance path of the printing medium. Moreover, when the printing medium passes through a drying mechanism, the printing medium is prone to meandering caused by, for example, contraction. Accordingly, in the configuration where the color chart recorded on the printing medium consists of patches in numerous colors arranged in the conveyance direction, acquiring accurate colorimetric data from the color chart requires the color chart to have sufficiently large color patches. However, increasing the size of the color patches in the color chart results in reduced areas for printing images based on actual print jobs.

It should be noted that the technology disclosed in Japanese Laid-Open Patent Publication No. 2013-111777 adjusts the position of the printing medium in the conveyance direction by, for example, reversing the conveyance of the printing medium. More specifically, this technology is used to deal with the displacement of the printing medium in the conveyance direction using the conveyance confirmation chart as shown in FIG. 34, which consists of a plurality of patches (typically, black patches) arranged in a direction normal to the conveyance direction (this direction extends along the width of the printing medium and will be referred to below as the “medium width direction”) while deviating from one another in the conveyance direction. Accordingly, this technology cannot be applied to deal with the displacement of the printing medium in the direction perpendicular to the conveyance direction (i.e., in the medium width direction).

To address this problem, it is conceivable to detect the displacement in the medium width direction concerning the relative position between the colorimeter and the printing medium, using a conveyance confirmation chart, similar to the one shown in FIG. 34 but with a plurality of patches arranged in the conveyance direction while deviating from one another in the medium width direction (this chart will be referred to below as the “measurement position confirmation chart”). However, the displacement might not be accurately detected depending on the positional relationship in the medium width direction between the patches on the measurement position confirmation chart and a reading spot of the colorimeter.

### SUMMARY OF THE INVENTION

Therefore, it is desired to accurately detect the displacement of the measurement position in the medium width direction when performing color measurements on a color chart while ensuring sufficient areas on a printing medium for images based on actual print jobs.

One aspect of the present invention provides a printing device for recording a color image on a printing medium, including:
a conveyance mechanism configured to convey the printing medium in a first direction;
a printhead configured to record the color image on the printing medium;
a reader configured to perform color measurements on a color chart by reading the color chart at a reading spot of a predetermined size, the color chart being recorded on the printing medium by the printhead and including a plurality of color patches arranged in the first direction; and
a control portion configured to control the conveyance mechanism, the printhead, and the reader, wherein,
the control portion executes:
   an image printing process for controlling the conveyance mechanism and the printhead to record the color chart on the printing medium along with the color image serving as a printing target;
   a position detection chart printing process for controlling the conveyance mechanism and the printhead to record a position detection chart on the printing medium to detect a position of the reading spot where the color chart is read, the position detection chart being recorded at a position corresponding to a position of the color chart on the printing medium in a second direction perpendicular to the first direction and parallel to the printing medium;
   a position detection chart reading process for controlling the conveyance mechanism and the reader such that the reader reads the position detection chart recorded on the printing medium; and
   a position detection process for detecting, as a current measurement position, a position of the reading spot in the second direction relative to the position detection chart recorded on the printing medium, based on read data obtained by the reader in the position detection chart reading process, and
the position detection chart includes:
   a reference pattern with a larger dimension in the second direction than a dimension of the reading spot in the second direction; and
   a detection pattern including within a range defined by the reference pattern in the second direction, either a plurality of patches arranged in the first direction while sequentially deviating from one another in the second direction or a linear pattern with a predetermined width extending obliquely relative to the first direction.

In this configuration, the color chart with the color patches arranged in the first direction, i.e., the direction in which the printing medium is conveyed, is recorded on the printing medium along with the color image serving as the printing target. The printhead records the position detection chart on the printing medium, allowing the detection of the position of the reading spot, as the measurement position, where the reader reads the color chart for the purpose of color measurements. The position detection chart includes the reference pattern and the detection pattern. In the second direction, the dimension of the reference pattern is larger than that of the reading spot. The detection pattern includes the patches arranged in the first direction while deviating from one another in the second direction, or the linear pattern with the predetermined width, extending obliquely relative to the first direction. While the printing medium is being conveyed in the first direction, the reader reads the position detection chart on the printing medium, thereby obtaining read data containing colorimetric values for a plurality of different positions in the first direction. Based on the read data, the position of the reading spot in the second direction relative to the position detection chart is detected as the current measurement position (where the reader performs color measurements the color chart at that specific time).

In the above aspect of the invention, the printing device may be configured as follows. The detection pattern includes the plurality of patches. The reference pattern and the plurality of patches have the same color. The reader is a colorimeter. In the position detection chart reading process, the control portion controls the conveyance mechanism and the colorimeter such that the colorimeter obtains colorimetric values including a reference measurement value for the reference pattern and detection pattern measurement values for a plurality of positions in the first direction respectively corresponding to the plurality of patches. In the position detection process, the control portion detects, as the current measurement position, the position of the reading spot in the second direction relative to the position detection chart recorded on the printing medium, based on the reference measurement value and the detection pattern measurement values.

As in the above configuration, when the reference pattern and the plurality of patches in the detection pattern have the same color, the position of the reading spot in the second direction can be determined as the current measurement position with reference to the configuration of the detection pattern. This determination is based on identifying, among different positions in the first direction corresponding to their respective patches, the position that corresponds to a colorimetric value generally equal to the colorimetric value for the reference pattern among colorimetric values for the different positions. Note that the wording “generally equal to” as used herein is intended to mean “either is an exact match to or falls within a predetermined error range of”.

Furthermore, in the above aspect of the invention, the printing device may further include a moving mechanism configured to move the reader in the second direction. In this scenario, the control portion determines a deviation amount from an appropriate position of the reading spot in the second direction where the color chart is read, based on the current measurement position detected in the position detection process. The control portion then controls the moving mechanism based on the deviation amount to place the reading spot at the appropriate position in the second direction.

As long as the appropriate measurement position for the color chart is determined by a position in the second direction relative to the position detection chart, the deviation amount at the measurement position or at the reading spot in the second direction can be calculated based on the detected current measurement position, as in the above configuration. Adjusting the position of the reader in the second direction in accordance with the deviation amount allows accurate color measurements on the color chart recorded on the printing medium. Thus, highly precise color measurements can be performed on the color chart without increasing the dimension of the color chart in the second direction, i.e., the medium width direction.

Another aspect of the present invention provides a color measurement position detection method for detecting, as a measurement position, a position of a reading spot where a reader of a printing device that records a color image on a printing medium reads a color chart recorded on the printing medium, wherein,
the printing device includes a conveyance mechanism configured to convey the printing medium in a first direction, a printhead configured to record the color image on the printing medium, and the reader,
the reader performs color measurements on the color chart by reading the color chart at the reading spot after the printhead records the color chart on the printing medium with a plurality of color patches arranged in the first direction,
the method includes:
   an image printing step of causing the conveyance mechanism and the printhead to record the color chart on the printing medium along with the color image serving as a printing target;
   a position detection chart printing step of causing the conveyance mechanism and the printhead to record a position detection chart on the printing medium to detect the position of the reading spot where the color chart is read, with the position detection chart being recorded at a position corresponding to a position of the color chart on the printing medium in a second direction perpendicular to the first direction and parallel to the printing medium;
   a position detection chart reading step of causing the reader to read the position detection chart recorded on the printing medium; and
   a position detection step for detecting, as a current measurement position, a position of the reading spot in the second direction relative to the position detection chart recorded on the printing medium based on read data obtained by the reader in the position detection chart reading step, and
the position detection chart includes:
   a reference pattern with a larger dimension in the second direction than a dimension of the reading spot in the second direction; and
   a detection pattern including within a range defined by the reference pattern in the second direction, either a plurality of patches arranged in the first direction while sequentially deviating from one another in the second direction or a linear pattern with a predetermined width extending obliquely relative to the first direction.

Yet another aspect of the present invention provides a non-transitory computer-readable recording medium containing a color measurement position detection program for detecting, as a measurement position, a position of a reading spot where a reader of a printing device that records a color image on a printing medium reads a color chart recorded on the printing medium, wherein,
the printing device includes a conveyance mechanism configured to convey the printing medium in a first direction, a printhead configured to record the color image on the printing medium, and the reader,
the reader performs color measurements on the color chart by reading the color chart at the reading spot after the printhead records the color chart on the printing medium with a plurality of color patches arranged in the first direction,
the measurement position detection program causes a computer included in the printing device to execute:
   an image printing step of causing the conveyance mechanism and the printhead to record the color chart on the printing medium along with the color image serving as a printing target;
   a position detection chart printing step of causing the conveyance mechanism and the printhead to record a position detection chart on the printing medium to detect the position of the reading spot where the color chart is read, with the position detection chart being recorded at a position corresponding to a position of the color chart on the printing medium in a second direction perpendicular to the first direction and parallel to the printing medium;
   a position detection chart reading step of causing the reader to read the position detection chart recorded on the printing medium; and
   a position detection step for detecting, as a current measurement position, a position of the reading spot in the second direction relative to the position detection chart recorded on the printing medium based on read data obtained by the reader in the position detection chart reading step, and
the position detection chart includes:
   a reference pattern with a larger dimension in the second direction than a dimension of the reading spot in the second direction; and
   a detection pattern including within a range defined by the reference pattern in the second direction, either a plurality of patches arranged in the first direction while sequentially deviating from one another in the second direction or a linear pattern with a predetermined width extending obliquely relative to the first direction.

These and other objectives, features, modes, and effects of the invention will become more apparent from the following detailed description of the invention with reference to the accompanying drawings.

### BRIEF DESCRIPTION OF THE DRAWINGS

FIG. 1 is an overall configuration diagram of a printing system using a printing device according to a first embodiment of the present invention;

FIG. 2 is a schematic diagram illustrating a configuration example of the printing device according to the first embodiment;

FIG. 3 is a schematic top view of an essential part of a printing mechanism in the first embodiment;

FIG. 4 consists of plan views (A) and (B) for describing the arrangement configuration of a colorimeter and an inline scanner in the first embodiment;

FIG. 5 is a block diagram illustrating the hardware configuration of a printing control device in the printing device according to the first embodiment;

FIG. 6 consists of diagrams (A) and (B) for describing a measurement position detection method for a printing device in a comparative example of the first embodiment;

FIG. 7 consists of diagrams (A) and (B) for describing problems encountered when using a measurement position detection chart in the comparative example;

FIG. 8 is a flowchart showing the procedure of a control process of the printing device according to the first embodiment;

FIG. 9 is a flowchart showing the procedure of a measurement position adjustment process in the control process for the printing device according to the first embodiment;

FIG. 10 consists of diagrams (A) and (B) for describing the measurement position adjustment process in the first embodiment;

FIG. 11 is a flowchart showing the procedure of an initial position setting process for setting an initial position of the colorimeter in the first embodiment;

FIG. 12 consists of diagrams (A), (B), (C), and (D) for describing a color measurement position detection method in a second embodiment of the present invention;

FIG. 13 is a flowchart showing the procedure of a measurement position adjustment process in the second embodiment;

FIG. 14 consists of diagrams (A), (B), (C), and (D) for describing another example of the measurement position adjustment process in the second embodiment;

FIG. 15 consists of diagrams (A) and (B) for describing a problem to be addressed by a measurement position adjustment process of a printing device according to a third embodiment of the present invention;

FIG. 16 consists of diagrams (A) and (B) for describing another problem to be addressed by the measurement position adjustment process in the third embodiment;

FIG. 17 is a flowchart showing the procedure of the measurement position adjustment process in the third embodiment;

FIG. 18 consists of diagrams (A), (B), (C), and (D) for describing a measurement position detection method in a fourth embodiment of the present invention;

FIG. 19 consists of diagrams (A) and (B) for describing a method for obtaining an appropriate patch size for a measurement position detection process in a fifth embodiment of the present invention;

FIG. 20 is a flowchart showing the procedure of a patch size detection process in the fifth embodiment;

FIG. 21 consists of diagrams (A) and (B) for describing a measurement position detection method in a sixth embodiment of the present invention;

FIG. 22 is a flowchart showing the procedure of a measurement position adjustment process in the sixth embodiment;

FIG. 23 consists of diagrams (A), (B), (C), (D), and (E) for describing a measurement position detection method in a seventh embodiment of the present invention;

FIG. 24 is a flowchart showing the procedure of a measurement position adjustment process in the seventh embodiment;

FIG. 25 consists of diagrams (A) and (B) for describing a method for detecting printing paper meandering in an eighth embodiment of the present invention;

FIG. 26 is a flowchart showing a first example of an anti-meandering process in the eighth embodiment;

FIG. 27 consists of diagrams (A) and (B) for describing an approach for handling printing paper meandering in the eighth embodiment;

FIG. 28 is a flowchart showing a second example of the anti-meandering process in the eighth embodiment;

FIG. 29 consists of diagrams (A) and (B) for describing a printing paper meandering amount detection method in a ninth embodiment of the present invention;

FIG. 30 consists of diagrams (A) and (B) to be referenced along with (A) and (B) of FIG. 29, for describing the printing paper meandering amount detection method in the ninth embodiment;

FIG. 31 is a flowchart showing the procedure of a meandering amount detection process in the ninth embodiment;

FIG. 32 is a flowchart showing the procedure of an anti-meandering process using the meandering amount detection process in the ninth embodiment;

FIG. 33 consists of diagrams (A) and (B) for describing a measurement position detection method in a tenth embodiment of the present invention; and

FIG. 34 is a diagram illustrating a conveyance confirmation chart for a conventional inkjet recording device.

### DETAILED DESCRIPTION OF THE INVENTION

Hereinafter, some embodiments of the present invention will be described with reference to the accompanying drawings. Note that the direction that is perpendicular to a direction in which to convey printing paper and parallel to the printing paper will be referred to below as the “paper width direction”. The conveyance direction of the printing paper and the paper width direction will be denoted as first and second directions, respectively. Additionally, colorimetric values obtained by a colorimeter are assumed below to be density values, but may instead represent luminance, spectral reflectance, the lightness L* in the Lab color space as defined by the International Commission on Illumination (CIE), or saturation.

### 1. First Embodiment

### 1.1 Overall Configuration of Printing System

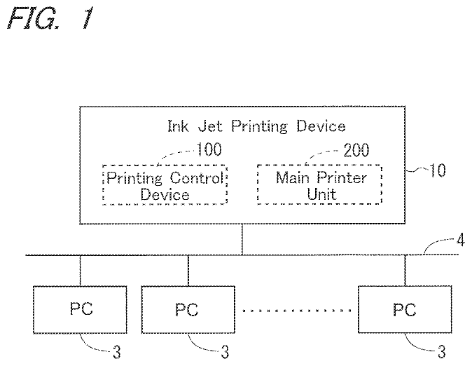

FIG. 1 is an overall configuration diagram of a printing system using a printing device according to a first embodiment of the present invention. This printing system includes the inkjet printing device 10 according to the present embodiment and a plurality of personal computers 3 (referred to below as the “PCs”). The inkjet printing device 10 and the PCs 3 are connected to each other via a known communication means, such as a LAN (local area network) 4. The inkjet printing device 10 includes a printing control device 100 and a main printer unit 200. The printing control device 100 serves as a control portion to control the operation of the main printer unit 200. Also, the printing control device 100 has installed therein a printing workflow management system, which is application software for managing printing workflow. Further, the printing control device 100 generates print data by performing, for example, RIP processing on manuscript data, such as PDF files, provided by the PCs 3. The main printer unit 200 prints an image on printing paper serving as a printing medium without using a printing plate, based on the print data generated by the printing control device 100. The PCs 3 are used to perform various operations on, for example, the printing workflow management system installed in the printing control device 100.

### 1.2 Configuration of Printing Device

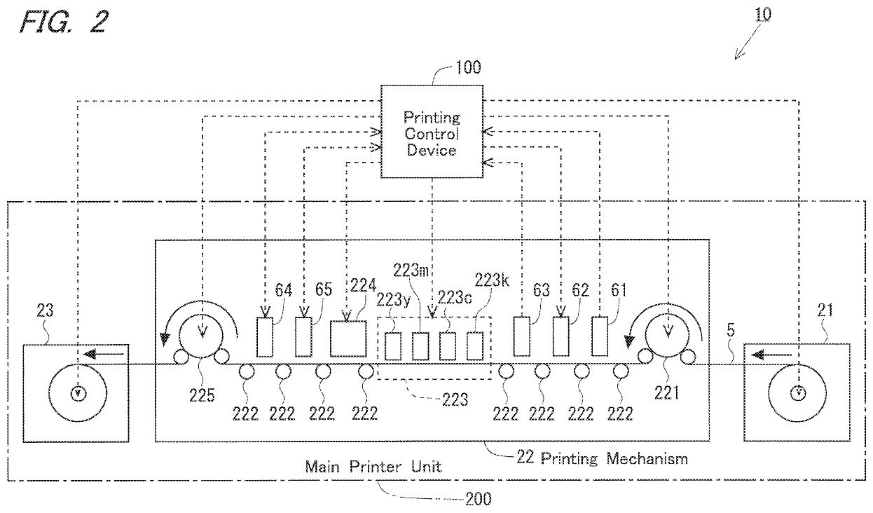

FIG. 2 is a schematic diagram illustrating a configuration example of the inkjet printing device 10 according to the present embodiment. As described above, the inkjet printing device 10 includes the printing control device 100 and the main printer unit 200.

The main printer unit 200 includes a paper feeding portion 21, a printing mechanism 22, and a paper winding portion 23. The paper feeding portion 21 is configured to supply the printing mechanism 22 with printing paper 5 (in this example, a roll of printing paper). The printing mechanism 22 is configured to print on the printing paper 5. The paper winding portion 23 is configured to roll up the printing paper 5 after printing.

The printing mechanism 22 includes a first drive roller 221, a plurality of support rollers 222, a recording portion 223, a drying mechanism 224, and a second drive roller 225. The first drive roller 221 is configured to convey the printing paper 5 inside. The support rollers 222 are configured to convey the printing paper 5 within the printing mechanism 22. The recording portion 223 is configured to print an image on the printing paper 5. The drying mechanism 224 is configured to dry the printing paper 5 having thereon the print image recorded. The second drive roller 225 is configured to eject the printing paper 5 from inside the printing mechanism 22. The paper feeding portion 21, the first drive roller 221, the support rollers 222, the second drive roller 225, and the paper winding portion 23 realize a conveyance mechanism for conveying the printing paper 5 in a predetermined conveyance direction. The recording portion 223 includes one or more ink discharge heads 223k for discharging K (black) ink, one or more ink discharge heads 223c for discharging C (cyan) ink, one or more ink discharge heads 223m for discharging M (magenta) ink, and one or more ink discharge heads 223y for discharging Y (yellow) ink.

Furthermore, the printing mechanism 22 includes an edge detection sensor 61, a meandering correction mechanism 62, a cue mark detection sensor 63, a colorimeter 64, and an inline scanner 65. The edge detection sensor 61 is configured to detect the position of an edge of the printing paper 5 in the paper width direction (referred to below as the “edge position”) while the printing paper 5 is being conveyed by the conveyance mechanism. The meandering correction mechanism 62 is configured to adjust the position of the printing paper 5 in the paper width direction based on the edge position detected by the edge detection sensor 61 and the size of the printing paper 5. The cue mark detection sensor 63 is configured to detect a cue mark representing the start position of a print area for each page. The colorimeter 64 is configured to perform color measurements on a predetermined portion of an image printed on the printing paper 5 by the recording portion 223. The inline scanner 65 serves as an imaging device for capturing the printed image. The edge detection sensor 61, the cue mark detection sensor 63, the colorimeter 64, and the inline scanner 65 obtain an edge detection signal, a cue mark detection signal, colorimetric data, and captured image data, respectively, all of which are sent to the printing control device 100.

It should be noted that the configuration of the main printer unit 200 shown in FIG. 2 is a mere example and not intended to be limiting. For example, the main printer unit 200 may be configured without the cue mark detection sensor 63 or with a plurality of meandering correction mechanisms 62.

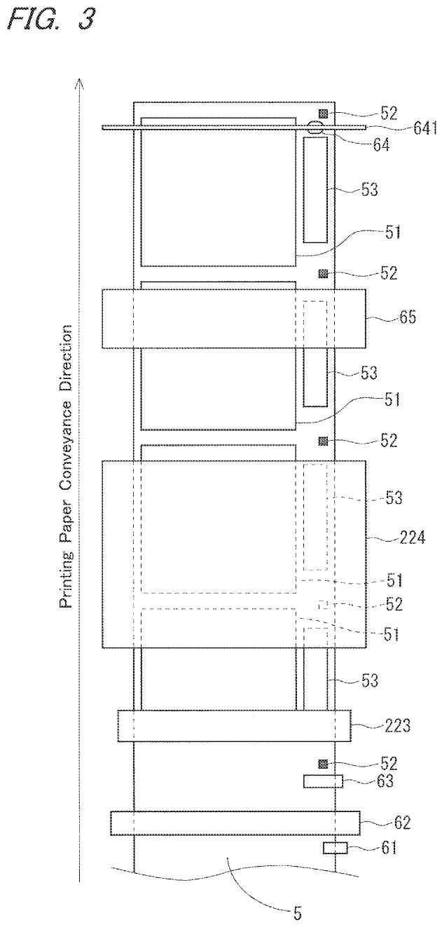

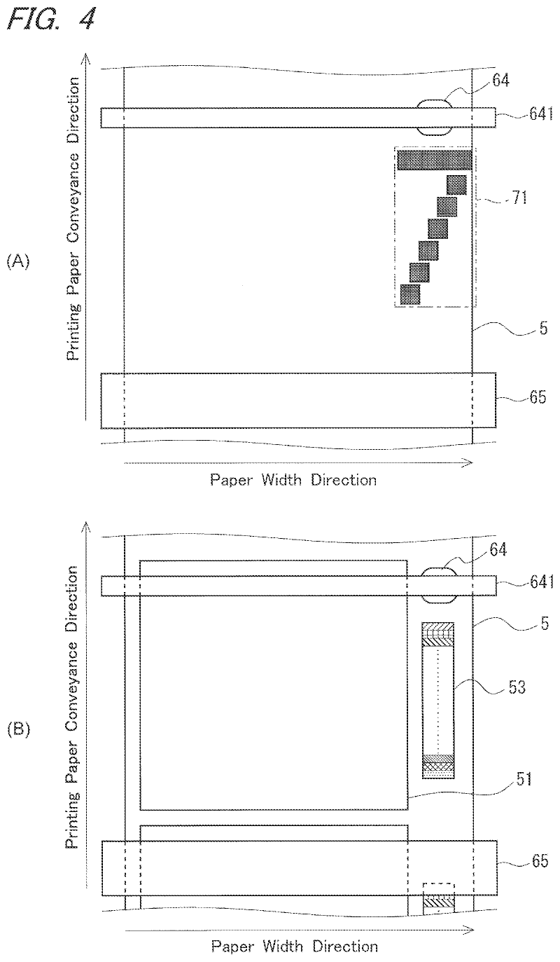

FIG. 3 is a schematic top view of an essential part of the printing mechanism 22. The printing paper 5 is conveyed from bottom to top in FIG. 3. While the printing paper 5 is conveyed, the edge detection sensor 61 detects the edge position, and the meandering correction mechanism 62 adjusts the position of the printing paper 5 based on the edge position and the size of the printing paper 5. Subsequently, the cue mark detection sensor 63 detects a cue mark 52, and the recording portion 223 then prints an image. At this time, the image is printed as a target print image in a predetermined actual image printing area 51 based on a printing job. Additionally, outside the actual image printing area 51, a color chart 53, which consists of numerous color patches arranged in the conveyance direction, is recorded for color measurements (see (B) of FIG. 4 to be described later). The printing paper 5 having thereon the print image recorded is dried as the printing paper 5 passes through the drying mechanism 224. Thereafter, the colorimeter 64, serving as a reader, performs color measurements on the color chart 53, and the inline scanner 65 captures the printed image.

(A) and (B) of FIG. 4 are plan views describing the arrangement configuration of the colorimeter 64 and the inline scanner 65. More specifically, (A) of FIG. 4 is a plan view where color measurements are performed on a measurement position detection chart 71 to be described later, and (B) of FIG. 4 is a plan view where color measurements are performed on the color chart 53. In the paper width direction, the measurement position detection chart 71 is larger than the color chart 53 to such an extent as to sufficiently cover the range of the color chart 53. The measurement position detection chart 71 and the color chart 53 are recorded on the printing paper 5 such that both charts approximately coincide at their center positions in the paper width direction. The colorimeter 64 is a device for outputting colorimetric values, such as CMYK density values and Lab values, representing absolute color information in conformity with, for example, the International Commission on Illumination (CIE) standards without being affected by environmental factors, such as temperature. The colorimeter 64 is designed to perform spot color measurements on a predetermined small area of a printed image, and a colorimeter moving mechanism 641 is provided and configured to move the colorimeter 64 to a position for color measurements. The colorimeter moving mechanism 641 is capable of moving the colorimeter 64 in the paper width direction at least across the entire width of the printing paper 5. The colorimeter moving mechanism 641 includes, for example, a guide member for guiding the colorimeter 64, a feeding mechanism for moving the colorimeter 64, such as a rack and pinion or a feeding screw, and a motor serving as a driving source for the feeding mechanism.

The inline scanner 65 includes a plurality of imaging elements arranged across a length corresponding to the entire width of the printing paper 5. Examples of the inline scanner 65 include a contact image sensor (CIS) and a charge-coupled device (CCD). The inline scanner 65 is configured to acquire RGB luminance values using color filters and output captured image data containing the RGB luminance values.

### 1.3 Configuration of Printing Control Device

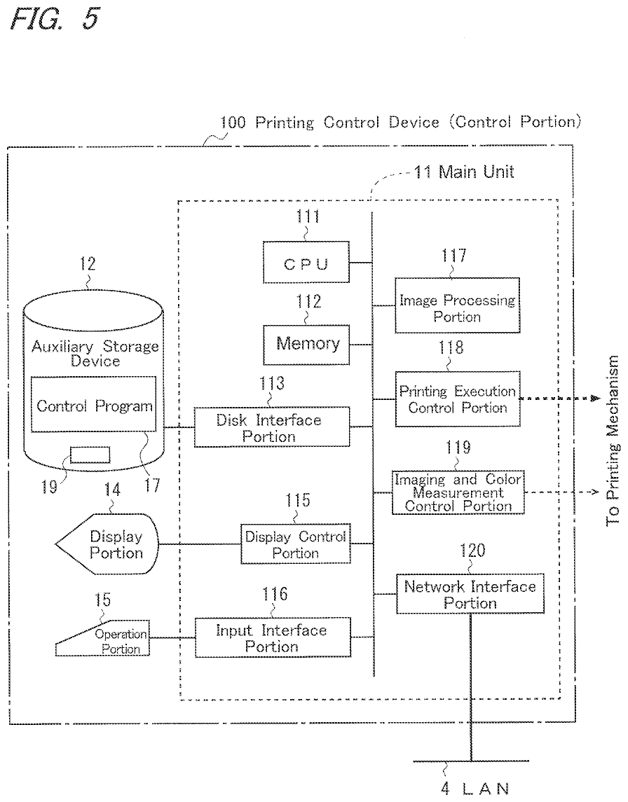

FIG. 5 is a block diagram illustrating the hardware configuration of the printing control device 100 serving as the control portion of the inkjet printing device 10. The printing control device 100 includes a main unit 11, an auxiliary storage device 12, a display portion 14, and an operation portion 15. The main unit 11 includes a CPU 111, memory 112, a disk interface portion 113, a display control portion 115, an input interface portion 116, an image processing portion 117, a printing execution control portion 118, an imaging and color measurement control portion 119, and a network interface portion 120. The CPU 111, the memory 112, the disk interface portion 113, the display control portion 115, the input interface portion 116, the image processing portion 117, the printing execution control portion 118, the imaging and measurement control portion 119, and the network interface portion 120 are connected to one another via a system bus. The disk interface portion 113 is connected to the auxiliary storage device 12. The display control portion 115 is connected to the display portion 14. The input interface portion 116 is connected to the operation portion 15, which includes a keyboard and a mouse. The network interface portion 120 is connected to the LAN 4, through which the control portion 100 is connected to the PCs 3 (see FIG. 1). The auxiliary storage device 12 is a magnetic disk device or suchlike. The display portion 14 is a liquid crystal display device or suchlike. The display portion 14 is used for the operator to display desired information. The operation portion 15 is used for the operator to input instructions to the inkjet printing device 10.

The auxiliary storage device 12 has stored therein a control program 17 for generating print data based on manuscript data received via the LAN 4 and causing the main printer unit 22 to print an image represented by the print data. As described earlier, the main printer unit 22 is provided with the inline scanner 65, serving as an imaging device, and the colorimeter 64, which perform image capture and color measurements, respectively, on images printed on the printing paper 5. The control program 17 is a program for performing, in addition to printing control to generate print data and cause the main printer unit 22 to print images, as described above, inspection control to assess the quality of the printed images using the inline scanner 65. The CPU 111 reads the control program 17 from the auxiliary storage device 12 onto the memory 112 and executes the program 17, thereby enabling the inkjet printing device 10 to fulfill functions such as printing an image on the printing paper 5 and assessing the quality of the printed image. Moreover, the execution of the control program 17 causes the colorimeter 64 to perform color measurements on the color chart 53 formed as a part of the printed image on the printing paper 5. Based on the result of the color measurements, the print data is corrected for color adjustments. The memory 112 includes a random access memory (RAM) and a read-only memory (ROM). The memory 112 functions as a work area for the CPU 111 to execute the control program 17.

It should be noted that the control program 17 is provided in the form of a computer-readable recording medium (non-transitory recording medium) with the control program 17 stored thereon. Specifically, the user purchases, for example, an optical disk as a recording medium containing the control program 17, and inserts the optical disk into an optical disk drive (not shown) connected to a computer serving as the printing control device 100, with the result that the control program 17 is read from the optical disk and installed into the auxiliary storage device 12.

The image processing portion 117, under control of the CPU 111 executing the control program 17, generates print data in a bitmap format by rasterizing manuscript data described in a page description language. The printing execution control portion 118 functions as an interface for the CPU 111 executing the control program 17 to control various portions of the main printer unit 22. The imaging and color measurement control portion 119 functions as an interface for the CPU 111 executing the control program 17 to control the inline scanner 65 and the colorimeter 64 to perform image capture and color measurements, respectively, on images printed on the printing paper 5.

### 1.4 Operation of Printing Device

In the present embodiment, when the CPU 111 reads and executes the control program 17 from the auxiliary storage device 12 onto the memory 112 (see FIG. 5), the control portion 100 controls various components of the main printer unit 200, such as the recording portion 223 and the conveyance mechanism, to print images on the printing paper 5. The control portion 100 also controls the inline scanner 65 to capture the printed images on the printing paper 5 and obtain captured image data, which is used to assess the quality of the printed images.

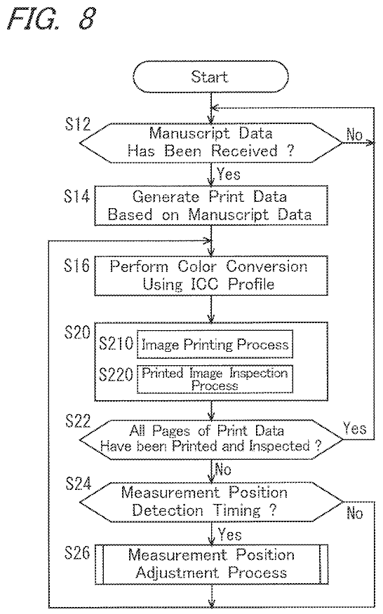

FIG. 8 is a flowchart showing the procedure of a control process of the printing device 10 (simply referred to below as a “control process”), including printing control process and inspection control process implemented by the CPU 111 executing the control program 17 in the present embodiment. In the printing device 10 according to the present embodiment, to print an input image (i.e., a target print image) represented by print data generated from manuscript data, the control portion 100, following the procedure shown in FIG. 8, controls the printing mechanism 22, along with the paper feeding portion 21 and the paper winding portion 23 (see FIGS. 2 and 3). To this end, the CPU 111 reads the program 17 from the auxiliary storage device 12 and executes the program 17 in the memory 112. As a result, the control process shown in FIG. 8 is activated, and the CPU 111, following the control program 17, operates as follows.

Initially, the procedure waits to receive manuscript data from any PC 3 of the printing system in FIG. 1 via the LAN 4 (step S12). When manuscript data is received from any PC 3, the image processing portion 117 is controlled to rasterize the manuscript data to generate print data in a bitmap format (step S14). The print data contains target image data, which is data for an input image represented by the manuscript data.

Next, the generated print data is subjected to color conversion using an ICC profile (step S16). Specifically, the ICC profile includes input and output profiles for color conversion. The input profile corresponds to an input device, and the output profile, which is also referred to as the “device profile”, corresponds to an output device (here, the inkjet printing device 10). The input and output profiles are stored in the auxiliary storage device 12 as a color conversion table and loaded into the memory 112 upon the execution of the color conversion.

This color conversion initially uses the input profile to convert the print data generated at step S14, which is in the form of YMCK data, into Lab data, which is device-independent color information. Then, the output profile is used to convert the Lab data back into YMCK data, resulting in print data compatible with the inkjet printing device 10.

The procedure advances to step S20 after the color conversion. At step S20, an image printing process (step S210) and a printed image inspection process (step S220) are executed concurrently. Note that in the present embodiment, steps S210 and S220 are executed on a page-by-page basis, and once steps S210 and S220 are executed on a page, it is determined at step S22 to be described later whether the page is the last page of the print data. Moreover, in the present embodiment, at least one timing is predetermined for detecting a measurement position for the colorimeter 64 (referred to below as a “measurement position detection timing”) within a time frame until the image printing process (step S210) and the printed image inspection process (step S220) are sequentially executed page-by-page up to the last page of the print data. Such a timing is specified in advance by, for example, elapsed time from the start of printing or the number of printed pages.

In the image printing process (step S210), various components, including the printing mechanism 22, are controlled based on the print data, i.e., the YMCK data obtained by the color conversion at step S16, to form target print images represented by the print data on the printing paper 5 based on a printing job. Specifically, to form the images represented by the print data on the printing paper 5, the recording portion 223, serving as a printhead including the ink discharge heads 223m, 223c, and 223k, is controlled along with the paper feeding portion 21, the drive rollers 221 and 225, the drying mechanism 224, the inline scanner 65, the colorimeter 64, and the paper winding portion 23 (see FIG. 2). As a result, the recording portion 223 sequentially records the target print images on the printing paper 5 being unwound and conveyed from the paper feeding portion 21. In other words, the target print images are sequentially formed on the printing paper 5. The target print images on the printing paper 5, formed in this sequential manner, are dried by the drying mechanism 224 and captured by the inline scanner 65 before the printing paper 5 is wound by the paper winding portion 23.

Furthermore, in the image printing process on the printing paper 5 (step S210), the target print image is recorded in the actual image printing area 51, while the color chart 53 for color measurements is recorded outside the actual image printing area 51 (see FIG. 3), as described earlier. By the time the printing paper 5 is wound by the paper winding portion 23 after undergoing drying by the drying mechanism 224 and other processing, the color chart 53 recorded on the printing paper 5 undergoes color measurements by the colorimeter 64 (see (B) of FIG. 4), resulting in colorimetric data. In the image printing process (step S210), the aforementioned output profile included in the ICC profile is updated based on the colorimetric data. As a result, the updated output profile is used during color conversion to be performed later at step S16, and therefore the inkjet printing device 10 makes color adjustments in accordance with the colorimetric data. Instead of involving such updating of the output profile, color adjustments may be made through updating a color correction lookup table (LUT) prepared independently of the ICC profile, based on the colorimetric data. In this case, color adjustments are made to print data for the next target page in the image printing process (step S210) using the color correction LUT, following the color conversion using the ICC profile at step S16. Note that while the colorimetric data acquired by the colorimeter 64 is used above to update the output profile, the colorimetric data may instead be used to correct print data having undergone RIP processing. As an example, when a reduction in C (cyan) density is detected based on the colorimetric data, the print data is corrected so as to increase the amount of C ink to be discharged.

In the printed image inspection process (step S220), the inline scanner 65 initially captures target print images being sequentially formed on the printing paper 5 in the image printing process (step S210), resulting in captured image data for the target print images. The captured image data is compared with, for example, the originally provided print data to assess the quality of the captured target print images. The assessment results are saved, displayed, and/or subjected to other processing by the printing control device 100. However, specific details of such processing are not relevant to the present invention and therefore are omitted herein.

After assessing one page for printed image quality, as described above, the printed image inspection process at step S220 ends, and the procedure advances to step S22.

At step S22, it is determined whether the printed image formation and inspection at steps S210 and S220 have completed printing and inspection on all pages of the print data. When the determination result indicates that any one page of the print data remains unprinted or uninspected, the procedure advances to step S24 to determine whether the measurement position detection timing has arrived. If the determination result indicates that the measurement position detection timing has occurred, the procedure returns to step S16 after executing a measurement position adjustment process (step S26). If the determination result indicates that the measurement position detection timing has not occurred, the procedure returns to step S16 without executing the measurement position adjustment process (step S26).

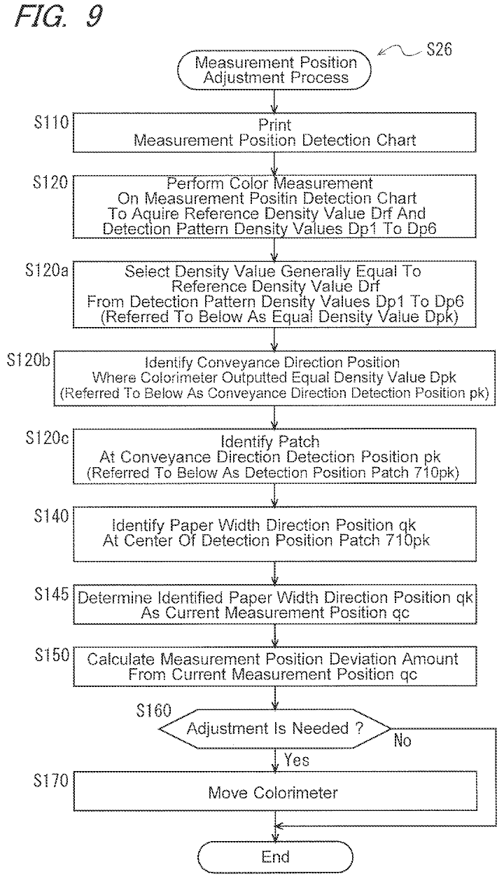

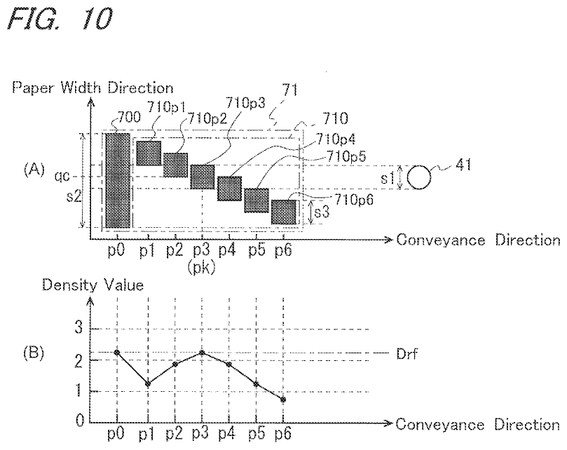

In the measurement position adjustment process (step S26), the current measurement position of the colorimeter 64 (more specifically, the position of a reading spot 41, which will be described later, in the paper width direction) is detected. If the detected measurement position deviates from an appropriate position for color measurements on the color chart, the colorimeter moving mechanism 641 is controlled to place the colorimeter 64 at the appropriate measurement position. The measurement position adjustment process (step S26) will be described in more detail later with reference to FIGS. 9 and 10.

After the procedure returns to step S16, as described above, steps S16 to S24 will be repeated until all pages of the print data are printed and inspected (if it is determined at step S24 that the measurement position detection timing has arrived, step S26 will also be executed). During this processing sequence, if it is determined at step S22 that all pages of the print data have been printed and inspected, the procedure returns to step S12, where a standby state continues until new manuscript data is received.

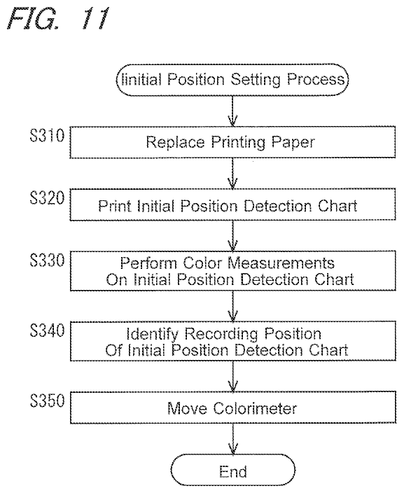

It should be noted that the measurement position adjustment process is routinely executed during printing (steps S24 and S26), as described above, and is also performed once to check the position accuracy of the colorimeter 64 after the colorimeter 64 is installed in the main unit of the printing device 10. Moreover, the measurement position adjustment process is also performed once immediately after an initial position setting process (FIG. 11), which will be described later and is executed after the replacement of the printing paper 5.

### 1.4.1 Measurement Position Adjustment Process

FIG. 9 is a flowchart showing the procedure of the measurement position adjustment process (step S26) in the present embodiment. In the measurement position adjustment process, a measurement position detection chart is formed on the printing paper 5 to be used for detecting the measurement position of the colorimeter 64 (step S110).

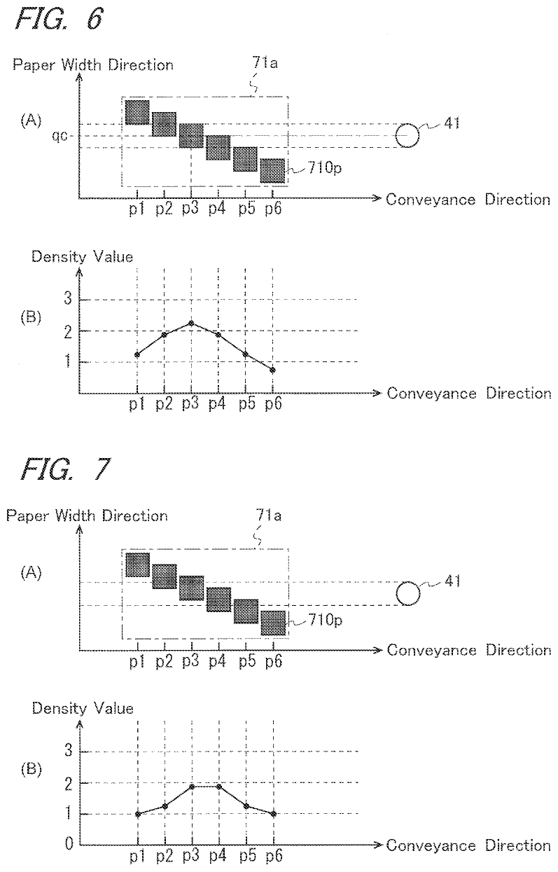

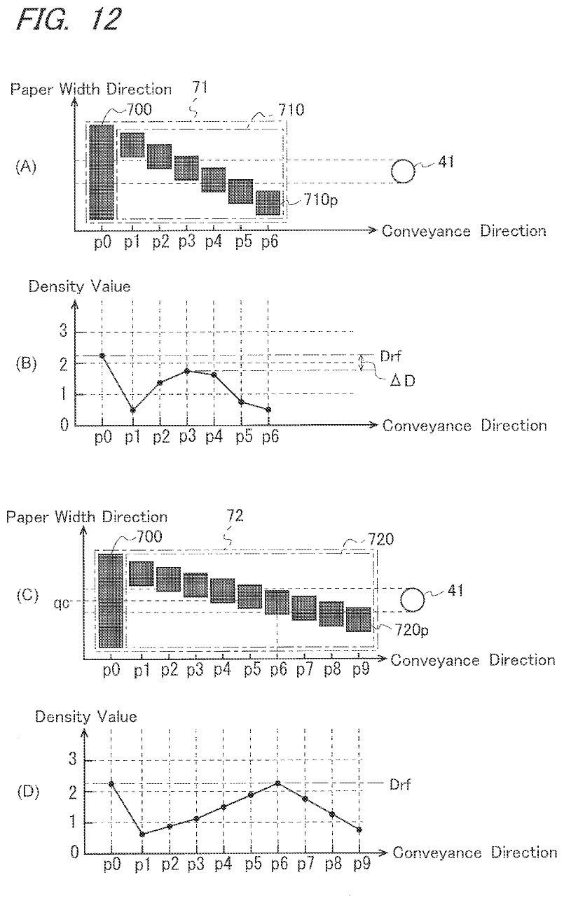

The measurement position detection chart used here can be a measurement position detection chart 71a as shown in (A) of FIG. 6, configured similarly to the conveyance confirmation chart as described earlier in conjunction with Japanese Laid-Open Patent Publication No. 2013-111777, but with a plurality of black patches arranged in the conveyance direction while deviating from one another in the medium width direction. The measurement position detection chart 71a will be referred to below as the “comparative detection chart” in the sense of a measurement position detection chart used in a comparative example. In (A) of FIG. 6, for the sake of convenience, the direction labeled as “CONVEYANCE DIRECTION” (from left to right in the figure) is opposite to the actual direction in which the printing paper 5 is conveyed, and the reading spot 41 of the colorimeter 64 moves relative to the “CONVEYANCE DIRECTION” as the printing paper 5 is conveyed. The same applies to (A) of FIG. 7 to be described later, and also to (A) of FIG. 10 and (A) of FIG. 12, and other figures, which illustrate measurement position detection charts in various embodiments. Here, the colorimeter 64 includes an optical reading system (not shown) with an aperture intervening in the middle and defining the size of the reading spot 41 (the range of color measurements or reading) of the colorimeter 64 on the printing paper 5.

The colorimeter 64 with the reading spot 41 reads such a comparative detection chart 71a on the printing paper 5 being conveyed, resulting in colorimetric data shown in (B) of FIG. 6. The colorimetric data shown in (B) of FIG. 6 represents density values obtained as colorimetric values by the colorimeter 64 performing color measurements on the comparative detection chart 71a at positions p1 to p6 corresponding to the centers of the patches 710p in the conveyance direction while the printing paper 5 is being conveyed. This colorimetric data indicates that the density value is maximized at the conveyance direction position p3 of the third patch in the comparative detection chart 71a.

Here, the relative positions and the size of the patches 710p included in the comparative detection chart 71a are predetermined. In this case, the disposition of the patches 710p on the printing paper 5 are known, and therefore the measurement position of the colorimeter 64 can be identified based on the conveyance direction position p3 corresponding to the peak colorimetric value in the colorimetric data. More specifically, the colorimeter 64 performs color measurements at the position qc in the paper width direction corresponding to the center of the patch 710p at the conveyance direction position p3, where the colorimetric value peaks. In this manner, the measurement position qc of the colorimeter 64 can be identified by the position of the reading spot 41 in the paper width direction in relation to the measurement position detection chart 71a recorded on the printing paper 5.

(A) and (B) of FIG. 7 are diagrams describing problems encountered when using the comparative detection chart 71a as described above. When the paper width direction position of the reading spot 41 of the colorimeter 64 falls between the paper width direction positions of two adjacent patches 710p in the comparative detection chart 71a, the reading spot 41 follows a path as represented by two parallel dotted lines in (A) of FIG. 7 in relation to the printing paper 5 as the printing paper 5 is conveyed. Consequently, color measurements by the colorimeter 64 result in colorimetric data as shown in (B) of FIG. 7, representing density values obtained as colorimetric values for the conveyance direction positions p1 to p6 of the patches. In this case, the colorimetric data lacks a distinct peak colorimetric value, and therefore, the measurement position of the colorimeter 64 cannot be identified from this colorimetric data. Moreover, when the paper width direction position of the reading spot 41 falls between the paper width direction positions of two adjacent patches 710p in the comparative detection chart 71a, even if the colorimetric data contains one distinct peak colorimetric value, the measurement position qc of the colorimeter 64 cannot be accurately identified based on the conveyance direction position that corresponds to that peak value.

To address such problems, the present embodiment uses a measurement position detection chart 71, which includes a black reference pattern 700 along with a detection pattern 710 made up of black patches 710p1 to 710p6, as shown in FIG. 10.

In the paper width direction, the reference pattern 700 has a dimension s2 larger than a dimension s1 of the reading spot 41 of the colorimeter 64. Thus, the reference pattern 700 can be reliably read even if the current measurement position of the colorimeter 64 (i.e., the current paper width direction position of the reading spot 41, simply referred to below as the “current measurement position”) slightly deviates from an appropriate measurement position in the paper width direction.

The patches 710p are arranged within a range defined by the reference pattern 700 in the paper width direction but outside of the reference pattern 700. Accordingly, in the paper width direction, the dimension s2 of the reference pattern 700 is larger than a dimension s3 of each patch 710p. In the paper width direction, the dimension s3 of each patch 710p is greater than or equal to the dimension s1 of the reading spot 41. However, in other embodiments to be described later, this does not limit the range of the dimension s3 of each patch 710p in the paper width direction. Moreover, it is assumed below that the reference pattern 700 and each patch 710p in the measurement position detection chart 71 are recorded in the same color on the printing paper 5, and this implies that the recording of the reference pattern 700 and each patch 710p is performed at the same density. The same applies to the measurement position detection charts in other embodiments.

In the measurement position adjustment process (FIG. 9) in the present embodiment, the CPU 111 in the printing control device 100 operates as will be described below. Note that, for the sake of convenience, the measurement position detection chart 71 will be described below as including six patches 710p, as shown in (A) of FIG. 10, but this does not limit the number of patches 710p in the measurement position detection chart 71. That is, the number of patches 710p may range from 2 to less than 6 or from 7 or more.

Initially, the recording portion 223, serving as the printhead, and the conveyance mechanism are controlled to form the measurement position detection chart 71, as shown in (A) of FIG. 10, on the printing paper 5 (step S110). Step S110 is executed as a position detection chart printing process. At step S110, it is preferable to control the recording portion 223 and the conveyance mechanism to form the measurement position detection chart 71 such that in the paper width direction, the center of the measurement position detection chart 71 approximately coincides with the center of a color chart 53 to be recorded on the printing paper 5 in the previously described image printing process (step S210) (see (A) and (B) of FIG. 4), but this is not limiting. For example, the measurement position detection chart 71 may be formed on the printing paper 5 such that in the paper width direction, one edge of the measurement position detection chart 71 approximately coincides with one edge of the color chart 53.

Next, the colorimeter 64 and the conveyance mechanism are controlled to perform color measurements on the measurement position detection chart 71 formed on the printing paper 5, by the colorimeter 64, serving as a reader, reading the measurement position detection chart 71 at the reading spot 41 (step S120). Step S120 is executed as a position detection chart reading process. This results in colorimetric data for the measurement position detection chart 71 shown in (A) of FIG. 10, containing seven colorimetric values (density values) respectively corresponding to conveyance direction positions p0, p1, p2, p3, p4, p5, and p6 at the centers of the reference pattern 700 and the six patches 710p1, 710p2, 710p3, 710p4, 710p5, and 710p6, as shown in (B) of FIG. 10. The density value outputted by the colorimeter 64 when the conveyance direction position p0 at the center of the reference pattern 700 reached the reading spot 41 will be referred to below as the reference density value Drf. Similarly, the density values outputted by the colorimeter 64 when the respective conveyance direction positions p1 to p6 at the centers of the patches 710p1 to 710p6 reached the reading spot 41 will be referred to below as the detection pattern density values Dp1 to Dp6, respectively.

Next, any one density value generally equal to the reference density value Drf (i.e., equal to the reference density value Drf within a predetermined error range) is selected from the detection density values Dp1 to Dp6 acquired at step S120 (step S120a). The selected density value will be referred to below as the equal density value Dpk. In the example shown in FIG. 10, k=3. Note that the density value selected at step S120a may be the closest density value to the reference density value Drf. Next, the conveyance direction position pk for which the colorimeter 64 outputted the equal density value Dpk (also referred to below as the “conveyance direction detection position”) is identified (step S120b). Then, the patch 710p at the conveyance direction detection position pk (referred to below as the “detection position patch 710pk”) is identified from among the patches 710p1 to 710p6 (S120c). Next, the paper width direction position qk at the center of the detection position patch 710pk is identified (step S140). The identified paper width direction position qk is determined as the current measurement position qc (step S145). Specifically, the paper width direction position qk at the center of the patch 710p with the equal density value Dpk is detected as the current measurement position qc. Note that steps S120a, 120b, 120c, S140, and S145 constitute a position detection process. Furthermore, steps S110 to S145 constitute a measurement position detection method in the present embodiment.

Thereafter, calculations are conducted to obtain a deviation amount Δq from a predetermined appropriate measurement position qn for the colorimeter 64 to perform color measurements on the color chart 53 (this amount will be referred to below as the “measurement position deviation amount”), i.e., Δq=qc−qn (step S150). The appropriate measurement position qn is a paper width direction position in relation to the measurement position detection chart 71 recorded on the printing paper 5 and will be regarded below as the center position of the reference pattern 700 within the measurement position detection chart 71 in the paper width direction (the same applies to other embodiments to be described later). However, this is not limiting, and the appropriate measurement position qn may be another paper width direction position of the reading spot 41 where color measurements can be accurately performed on the color chart 53 recorded on the printing paper 5 in the previously described image printing process (step S210).

Next, based on the measurement position deviation amount Δq as calculated above, whether to adjust the position of the colorimeter 64 is determined (step S160). Specifically, the determination involves using a predetermined tolerance value Δlim for the deviation amount of the colorimeter 64 from the appropriate measurement position qn in the paper width direction position. If |Δq|>Δlim, it is determined that the position of the colorimeter 64 needs adjustment, and if |Δq|Δlim, it is determined that there is no need to adjust the position of the colorimeter 64.

If the determination result at step S160 indicates that the position of the colorimeter 64 needs adjustment, the colorimeter moving mechanism 641 is controlled based on the measurement position deviation amount Δq such that the measurement position of the colorimeter 64 (i.e., the paper width direction position of the reading spot 41) coincides with the appropriate measurement position qn (see FIGS. 3 and 4) (step S170), and then the measurement position adjustment process (step S26) ends. If the determination result at step S160 indicates that there is no need to adjust the position of the colorimeter 64, the measurement position adjustment process (step S26) ends without moving the colorimeter 64.

### 1.5 Procedure for Setting Initial Position of Colorimeter

In the present embodiment, the inkjet printing device 10 uses various sizes of printing paper 5 as printing media. Moreover, the color chart 53 is not printed at the same position on every size of printing paper 5. Accordingly, in the present embodiment, the initial position of the colorimeter 64 is set every time the printing paper 5 is replaced. FIG. 11 is a flowchart showing the procedure of this initial position setting process. The initial position setting process is also executed in other embodiments to be described later. The procedure for setting the initial position of the colorimeter 64 will be described below with reference to FIG. 11. Note that while various sizes of printing paper 5 are assumed here for use as printing media, other printing media such as films and metal foils may also be used.

First, while the inkjet printing device 10 is not in operation, the operator replaces the printing paper 5 with new printing paper 5 (step S310). Next, a position detection chart for setting the initial position of the colorimeter 64 (referred to below as an “initial position detection chart”) is printed (step S320). More specifically, the CPU 111 controls the recording portion 223 and the conveyance mechanism to form the initial position detection chart on the new printing paper 5. The initial position detection chart can be any pattern, so long as the range of the reference pattern 700 in the paper width direction within the measurement position detection chart 71 to be formed on the printing paper 5 can be confirmed in the previously described measurement position adjustment process (FIG. 9) following the initial position setting process. Alternatively, the measurement position detection chart 71 may be formed on the printing paper 5 as the initial position detection chart at step S320.

Next, the CPU 111 controls the inline scanner 65 and the conveyance mechanism such that the inline scanner 65 performs color measurements on the initial position detection chart on the printing paper 5 after the drying mechanism 224 dries the initial position detection chart (step S330).

Subsequently, based on colorimetric data resulting from the color measurements at step S330, the recording position of the initial position detection chart is identified (step S340). For example, the recording position identified at step S340 is displayed by the display portion 123 of the printing control device 100.

The operator instructs the printing control device 100 to move the colorimeter 64 to a desired position while referencing the identified recording position. Then, the colorimeter 64 moves to the desired position (step S350).

In the present embodiment, once the printing paper 5 is replaced (i.e., step S310 is executed), the sequence from step S320 to step S350 is executed before the measurement position adjustment process as outlined in FIG. 9.

### 1.6 Effects

In the first embodiment, the conveyance direction position pk is the position for which the density value Dpk is generally equal to or closest to the density value (reference density value) Drf of the reference pattern 700 among the density values Dp1 to Dp6 for the conveyance direction positions p1 to p6 of the patches 710p1 to 710p6. The conveyance direction position pk is initially determined based on the colorimetric data resulting from color measurements on the measurement position detection chart, including the reference pattern 700, as shown in FIG. 10. Then, the paper width direction position qk of the patch 710pk printed at the conveyance direction position pk is identified. The paper width direction position qk of this patch 710pk is considered as the current measurement position qc of the colorimeter 64. Accordingly, the current measurement position qc can be accurately identified. If the current measurement position qc deviates from the appropriate position qn for color measurements on the color chart 53 (i.e., the appropriate colorimetric value), the amount of positional deviation is accurately detected. The colorimeter moving mechanism 641 can be controlled based on the amount of positional deviation such that the paper width direction position of the reading spot 41, i.e., the current measurement position qc, is located at the appropriate measurement position qn. As a result, the colorimeter 64 moves to the appropriate position for color measurements on the color chart 53. Thus, color measurements can be performed at the appropriate position without increasing the dimension of each color patch of the color chart 53 in the paper width direction. Moreover, based on the result of the color measurements, color adjustments can be accurately executed to deal with color variations in printed images caused by temporal and environmental changes.

It should be noted that in the present embodiment, it is important to accurately detect the positional deviation amount at the current measurement position qc. The means for eliminating the positional deviation is not limited to the colorimeter moving mechanism 641. For example, the positional deviation may be eliminated by manually moving the colorimeter 64 in the paper width direction. Alternatively, instead of moving the colorimeter 64 in the paper width direction, the printing position of the color patch 53 for color measurements on the printing paper 5 may be adjusted in the paper width direction such that the paper width direction position of the color patch 53 falls within the range defined by the current measurement position qc. Further, when the positional deviation amount at the current measurement position qc exceeds a tolerance value, the display portion 14 (see FIG. 5) or another component may present an alert message to notify the operator that the colorimeter 64 is unable to correctly read the color patch 53.

Furthermore, the measurement position adjustment process (FIG. 9) is executed once upon the installation of the colorimeter 64 into the main unit of the printing device 10. This allows for corrections in accordance with the positional precision of the installed colorimeter 64, ensuring that the colorimeter 64 is able to perform color measurements at an appropriate position. At this time, the amount of correction on positional deviation is taken into account in subsequent measurement position adjustment processes. Moreover, even when the printing paper 5 deviates in the paper width direction during printing, the measurement position adjustment process, which is routinely executed during printing (see steps S24 and S26 in FIG. 8), adjusts the measurement position of the colorimeter 64 in accordance with the deviation to ensure that color measurements are performed on the color chart 53 at an appropriate position.

### 2. Second Embodiment

Described next is a printing device 10 according to a second embodiment of the present invention. This printing device 10 is also an inkjet printing device including the same hardware configuration as in the first embodiment, and the control program 17 is the same as that in the first embodiment, except for elements related to the measurement position adjustment process (FIG. 9). Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the measurement position adjustment process.

(A), (B), (C), and (D) of FIG. 12 are diagrams describing a measurement position detection method in the present embodiment. The colorimeter 64 performs color measurements on a measurement position detection chart as shown in (A) of FIG. 12 to obtain colorimetric data consisting of detection pattern density values Dp1 to Dp6, which correspond to conveyance direction positions p1 to p6, respectively, of patches 710p included in a detection pattern 710, as shown in (B) of FIG. 12. Assuming that the closest of the density values Dp1 to Dp6 to the reference density value Drf is Dpk (in the example shown in (B) of FIG. 12, Dp3), when the difference ΔD between the reference density value Drf and the density value Dpk, i.e., ΔD=|Drf−Dpk|, exceeds a predetermined range, the measurement position adjustment process (FIG. 9) in the first embodiment fails to determine an accurate measurement position. In such a case, when color measurements are performed on the patch 710p corresponding to the closest density value Dpk to the reference density value Drf, the reading spot of the colorimeter 64 encompasses an unprinted area of paper, as can be appreciated from (A) of FIG. 12, resulting in a slightly lower density value Dpk than the reference density value Drf.

Accordingly, in the present embodiment, to deal with the above case, a new measurement position detection chart 72 as shown in (C) of FIG. 12 is formed on the printing paper 5 with adjacent patches deviating from each other in the paper width direction less than in the measurement position detection chart 71. The colorimeter 64 performs color measurements on the new measurement position detection chart 72 to obtain colorimetric data containing detection pattern density values Dp1 to Dp9, as shown in (D) of FIG. 12. Assuming that the closest of the density values Dp1 to Dp9 to the reference density value Drf is Dpk (in the example shown in (D) of FIG. 12, Dp6), when the density value Dpk is generally equal to the reference density value Drf (i.e., equal to the reference density value Drf within a predetermined error range), the paper width direction position of a patch 720p at a conveyance direction position pk corresponding to the density value Dpk is identified as the current measurement position qc (i.e., the paper width direction position of the reading spot 41).

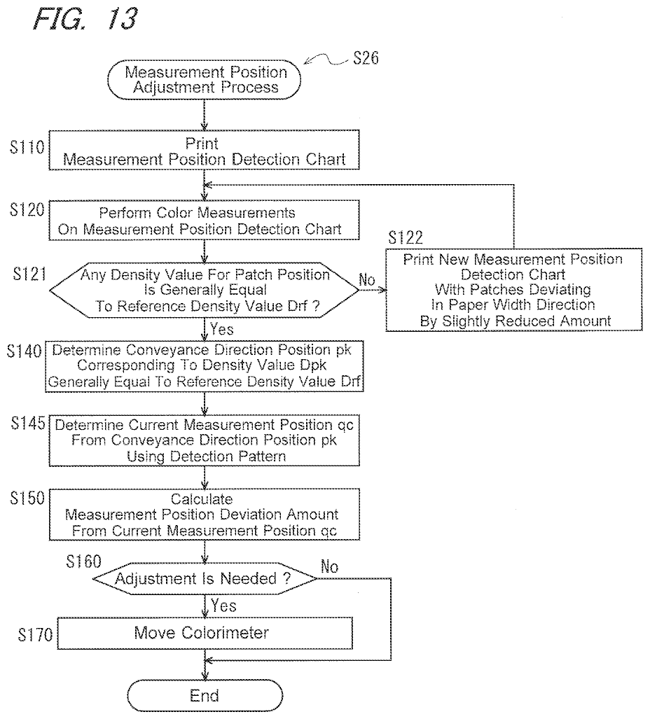

FIG. 13 is a flowchart showing the procedure of the measurement position adjustment process (step S26 in FIG. 8) in the present embodiment using the above measurement position detection method. Steps of the measurement position adjustment process that are the same as or correspond to those in the first embodiment (FIG. 9) are denoted by the same step numbers and will not be elaborated upon. In the measurement position adjustment process in the present embodiment, the CPU 111 operates as will be described below. Note that, for the sake of convenience, the following descriptions assume the use of the measurement position detection chart 71 with six patches 710p, as shown in (A) of FIG. 12, and the measurement position detection chart 72 with nine patches 720p, as shown in (B) of FIG. 12. However, the measurement position detection chart 71 may include seven or more patches 710p, and the measurement position detection chart 72 may include ten or more patches 720p.

In the measurement position adjustment process in the present embodiment, as shown in FIG. 13, color measurements are performed on the measurement position detection chart 71 ((A) of FIG. 12) formed on the printing paper 5 (step S120), resulting in colorimetric data containing detection pattern density values Dp1 to Dp6, which correspond to conveyance direction positions p1 to p6 of the patches. Then, it is determined whether any of the detection pattern density values Dp1 to Dp6 is equal to the reference density value Drf within a predetermined error range (step S121). More specifically, it is determined whether the difference ΔD between the reference density value Drf and the closest detection pattern density value Dn to the reference density value Drf among the detection pattern density values Dp1 to Dp6 within the colorimetric data, i.e., ΔD=|Drf−Dn|, is greater than a predetermined tolerance error e.

If the determination result indicates that ΔD>e, none of the detection pattern density values Dp1 to Dp6 are considered as equal to the reference density value Drf. In this case, the procedure advances to step S122, where the recording portion 223 and the conveyance mechanism are controlled to form a new measurement position detection chart 72 ((C) of FIG. 12) on the printing paper 5 without changing the configuration (i.e., the size and shape) of the reference pattern 700, except that the patches 710p deviate from one another in the paper width direction by a slightly reduced amount. Thereafter, the procedure returns to step S110, and then steps S120, S121, and S122 are repeated in this order until colorimetric data obtained by performing color measurements on any new measurement position detection chart formed on the printing paper 5 is determined to contain a detection pattern density value generally equal to the reference density value Drf (i.e., until the condition ΔD≤e is satisfied). During this processing sequence, if it is determined at step S121 that any of the detection pattern density values, such as those denoted by Dp1, DP2, Dp3, etc., contained in the colorimetric data obtained from the new measurement position detection chart is generally equal to the reference density value Drf, the procedure advances to step S140.

At and after step S140, similar to the measurement position adjustment process in the first embodiment (steps S140 to S170 in FIG. 9), the measurement position deviation amount Δq, i.e., the amount of deviation of the current measurement position qc from the appropriate measurement position qn, is determined based on the conveyance direction position pk corresponding to the density value Dpk, determined from among the detection pattern density values, such as those denoted by Dp1, DP2, Dp3, etc., to be generally equal to the reference density value Drf. Based on the measurement position deviation amount Δq, the paper width direction position of the colorimeter 64 is adjusted.

In the second embodiment described above, if the colorimetric data resulting from color measurements on the measurement position detection chart 71 on the printing paper 5 contains no detection pattern density value equal to the reference density value Drf within the predetermined error range, a new measurement position detection chart 72 is formed on the printing paper 5 with adjacent patches deviating from each other in the paper width direction by a slightly reduced amount. For the new measurement position detection chart 72 also, it is determined whether colorimetric data resulting therefrom contains any detection pattern density value equal to the reference density value Drf within the predetermined error range. The above operation will be repeated until any detection pattern density value contained in newly obtained colorimetric data is determined to be equal to the reference density value Drf within the predetermined error range. In this manner, setting an appropriate rate at which to reduce the amount of deviation between adjacent patches in the paper width direction ensures reliable detection of the accurate paper width direction position of the colorimeter 64. Based on the detection result, the measurement position deviation amount Δq is calculated and used to adjust the measurement position, i.e., the paper width direction position of the colorimeter 64. Therefore, even if the current measurement position qc deviates from the appropriate measurement position qn, it is still possible to ensure moving the colorimeter 64 to a suitable position for color measurements on the color chart 53 and performing accurate color measurements on the color chart 53. Thus, accurate color adjustments can be reliably performed to deal with color variations in printed images caused by temporal and environmental changes.

In the measurement position adjustment process in the second embodiment, if none of the detection pattern density values are equal to the reference density value Drf within the predetermined error range, the measurement position detection chart 72 is formed on the printing paper 5 with adjacent patches deviating from each other in the paper width direction by a slightly reduced amount, as shown in (C) of FIG. 12. Due to this reduced amount of deviation between adjacent patches in the paper width direction, the measurement position detection chart 72 has more patches (denoted by 720p) than the patches 710p of the measurement position detection chart in (A) of FIG. 12.

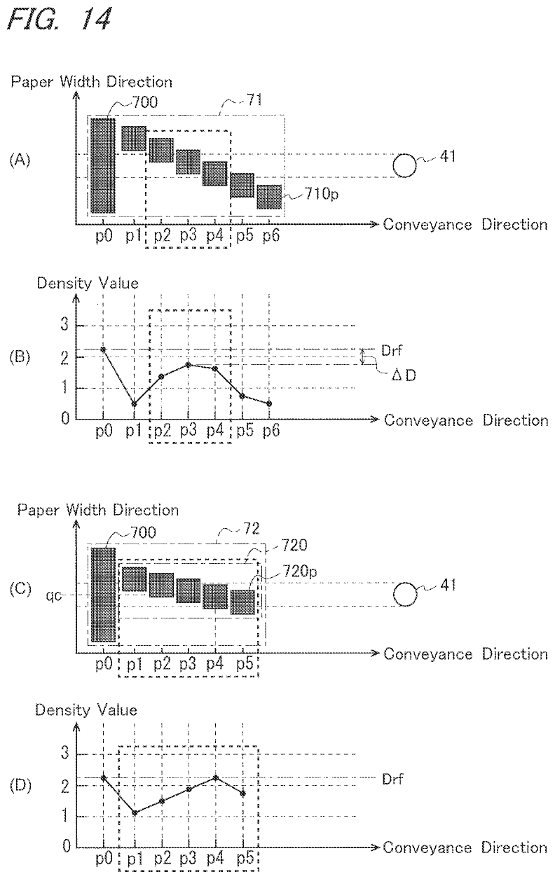

Accordingly, if there is no detection pattern density value equal to the reference density value Drf within the predetermined error range, it is preferable to form the measurement position detection chart 72 on the printing paper 5 with a reduced number of patches 720p. These patches 720p deviate from one another in the paper width direction by a reduced amount and are located within a range defined by a predetermined area around the paper width direction position of a patch 710p at a conveyance direction position pk corresponding to the closest density value Dpk to the reference density value Drf. More specifically, in the case of, for example, colorimetric data resulting from a measurement position detection chart 71 as shown in (A) of FIG. 14 and containing detection pattern density values Dp1 to Dp6, none of the detection pattern density values are equal to the reference density value Drf within the predetermined error range. In such a case, it is preferable to form a measurement position detection chart 72 on the printing paper 5 with five patches 720p arranged at respective conveyance direction positions p1 to p5 while deviating from one another in the paper width direction by a reduced amount, as shown in (C) of FIG. 14. These five patches 720p are located within a range defined by a predetermined area around the patch 710p at the conveyance direction position p3 within the measurement position detection chart 71, which correspond to the closest density value Dp3 to the reference density value Drf among the detection pattern density values Dp1 to Dp6. When step S122 is implemented in the measurement position adjustment process in FIG. 13 following such an approach outlined in FIG. 14, similar effects to those of the previously described measurement position adjustment process (see FIGS. 12 and 13) can be achieved with less processing.

As for the measurement position adjustment process in the second embodiment, even when a new measurement position detection chart 72 is formed on the printing paper 5 with the patches 720p deviating from one another in the paper width direction by a reduced amount, the pitch between adjacent patches 720p in the conveyance direction (referred to below as the “patch pitch”) remains unchanged (see (A) and (C) of FIG. 12). Alternatively, in the case of colorimetric data resulting from color measurements on a measurement position detection chart formed with a relatively wide patch pitch on the printing paper 5, where the colorimetric data contains detection pattern density values, such as those denoted by Dp1, DP2, etc., corresponding to patches 710p in the measurement position detection chart, and the closest density value Dpk to the reference density value Drf is identified among the detection pattern density values, the measurement position detection chart 72 may be formed on the printing paper 5 with a reduced number of patches 720p provided at a reduced patch pitch within a range defined by a predetermined area around the patch 710p corresponding to the closest density value Dpk. In this case, the following processing sequence will be repeated: colorimetric data is obtained for the above measurement position detection chart with the reduced patch pitch; and the closest density value Dk to the reference density value Drf is identified among all detection pattern density values contained in the colorimetric data. As a result, the density value Dpk equal to the reference density value Drf can be identified among the detection pattern density values within the predetermined error range, and then the current measurement position qc (i.e., the measurement position of the colorimeter at that specific time) can be identified from the patch 720p at the conveyance direction position pk corresponding to the equal density value Dpk.

### 3. Third Embodiment

Described next is a printing device 10 according to a third embodiment of the present invention. This printing device 10 is also an inkjet printing device including the same hardware configuration as in the first embodiment, and the control program 17 is the same as that in the first embodiment, except for elements related to the measurement position adjustment process. Note that the printing device 10 according to the present embodiment is provided with a cleaning mechanism and other components for, when the recording portion 223 has any discharge failure of the ink discharge heads, performing a maintenance process (wiping, purging, or flushing) to resolve the discharge failure. The specific configuration of the maintenance process is not strictly limited, and the configuration of the maintenance process employed by the printing device 10 is a well-known one. In the following, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the measurement position adjustment process.

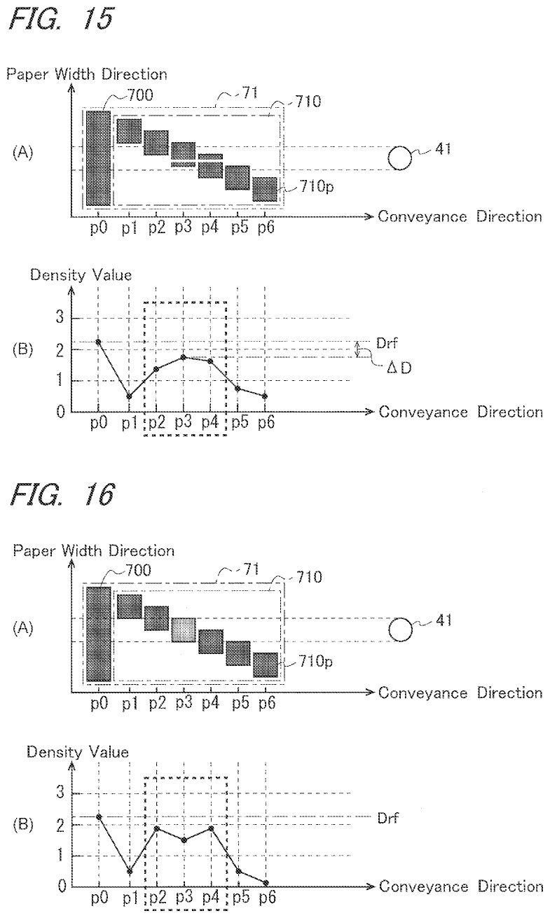

(A) and (B) of FIG. 15 are diagrams describing a problem to be addressed by the measurement position adjustment process of the printing device according to the present embodiment. For colorimetric data containing detection pattern density values Dp1 to Dp6, as obtained by performing color measurements on a measurement position detection chart 71, as shown in (A) of FIG. 15, formed on the printing paper 5, in some cases, the difference ΔD between the reference density value Drf and the closest of the detection pattern density values Dp1 to Dp6 to the reference density value Drf, i.e., Dp3, which is ΔD=Drf−Dp3|, as shown in (B) of FIG. 15, exceeds a predetermined tolerance value due to an ink discharge failure or other factors. In such cases, none of the detection pattern density values Dp1 to Dp6 are equal to the reference density value Drf within the predetermined error range. Therefore, the measurement position adjustment process as employed in the first embodiment cannot identify the measurement position.

(A) and (B) of FIG. 16 are diagrams describing another problem to be addressed by the measurement position adjustment process of the printing device 10 according to the present embodiment. For colorimetric data containing detection pattern density values Dp1 to Dp6, as obtained by performing color measurements on a measurement position detection chart 71, as shown in (A) of FIG. 16, formed on the printing paper 5, in some cases, more than one of the detection pattern density values Dp1 to Dp6, which correspond to conveyance direction positions p1 to p6, respectively, are maximal or minimal due to an ink discharge failure or other factors. In such cases also, none of the detection pattern density values Dp1 to Dp6 are equal to the reference density value Drf within the predetermined error range. Therefore, the measurement position adjustment process as employed in the first embodiment cannot identify the measurement position.

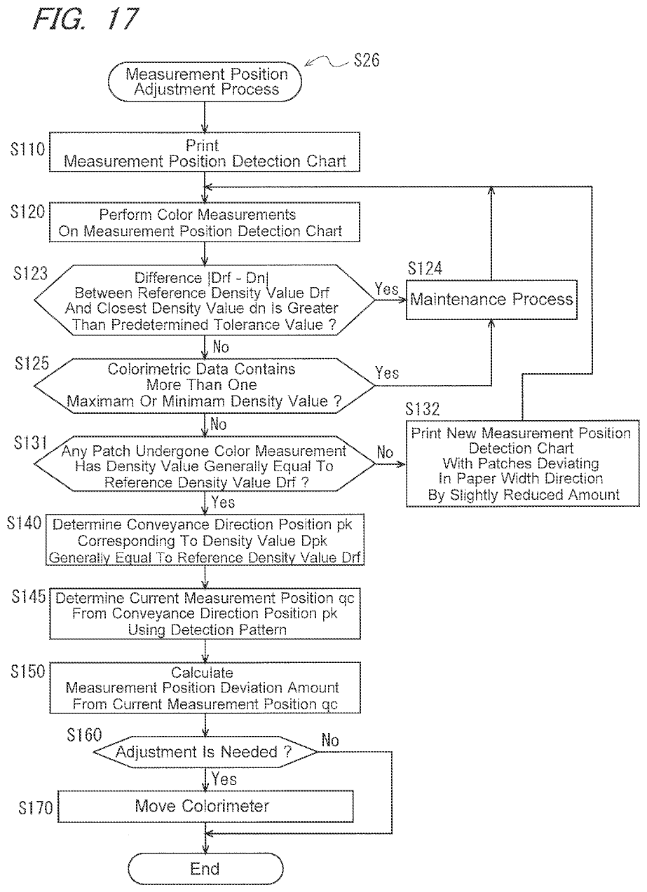

FIG. 17 is a flowchart showing the procedure of the measurement position adjustment process in the present embodiment. This measurement position adjustment process is designed to identify an accurate measurement position even when the measurement position adjustment process in the first embodiment fails due to an ink discharge failure or other factors, as described with reference to (A) and (B) of FIG. 15, and (A) and (B) of FIG. 16. In the present embodiment, steps of the measurement position adjustment process (FIG. 17) that are the same as or correspond to those in the first embodiment (FIG. 9) are denoted by the same step numbers and will not be elaborated upon. In the measurement position adjustment process in the present embodiment (FIG. 17), the CPU 111 operates as will be described below. Note that, for the sake of convenience, it is assumed below that the measurement position detection chart 71 with six patches 710p, as shown in (A) of FIG. 15 and (A) of FIG. 16, is formed on the printing paper 5, but the measurement position detection chart 71 may include seven or more patches 710p.

In the measurement position adjustment process in the present embodiment, as shown in FIG. 17, the colorimeter 64 performs color measurements on the measurement position detection chart 71 on the printing paper 5 (step S120), resulting in colorimetric data containing detection pattern density values Dp1 to Dp6. Then, it is determined whether the difference ΔD between the reference density value Drf and the closest detection pattern density value Dn to the reference density value Drf among the detection pattern density values Dp1 to Dp6, i.e., ΔD=|Drf−Dn|, is greater than a predetermined tolerance value (step S123).

When the determination result at step S123 indicates that the difference ΔD=|Drf−Dn| is greater than the predetermined tolerance value, the procedure advances to step S124 to perform a maintenance process. In the maintenance process, the cleaning mechanism (not shown) and/or the recording portion 223 are controlled to perform wiping, purging, or flushing to resolve any discharge failure of the ink discharge heads within the recording portion 223. Following the maintenance process, the procedure returns to step S120.

When the determination result at step S123 indicates that the difference ΔD=|Drf−Dn| is less than or equal to the predetermined tolerance value, the procedure advances to step S125 to determine whether the colorimetric data obtained at step S120 contains more than one maximal or minimal density value. When the determination result indicates that there are more than one maximal or minimal density value in the colorimetric data, the procedure advances to step S124 to perform the maintenance process as described above. Thereafter, the procedure returns to step S120. If the colorimetric data contains not more than one maximal or minimal density value, the procedure advances to step S131.

In the measurement position adjustment process of the present embodiment, steps S131 and S132 correspond to steps S121 and S122, respectively, in the measurement position adjustment process of the second embodiment (FIG. 13). Moreover, steps S140 to S170 in the measurement position adjustment process of the present embodiment are the same as those in the second embodiment (FIG. 13). Accordingly, in the present embodiment, the execution of the measurement position adjustment process follows the same procedure as in the second embodiment (FIG. 13), except for steps S123, S124, and S125, which are related to the maintenance process to be executed upon the occurrence of any ink discharge failure.

As described above, in the present embodiment, when accurate colorimetric data cannot be obtained by color measurements on the measurement position detection chart formed on the printing paper 5 due to any discharge failure of the ink discharge heads within the recording portion 223 (see FIGS. 15 and 16), the current measurement position qc (i.e., the measurement position of the colorimeter 64 at that specific time) is determined in the same manner as in the measurement position adjustment process of the second embodiment (FIG. 13), after the discharge failure is resolved by the maintenance process (step S124). Then, the position of the colorimeter 64 in the paper width direction is adjusted based on the measurement position deviation amount Δq calculated based on the determined current measurement position qc. Accordingly, accurate color adjustments can be performed more reliably to deal with color variations in printed images due to temporal and environmental changes.

### 4. Fourth Embodiment

Described next is a printing device 10 according to a fourth embodiment of the present invention. This printing device 10 is also an inkjet printing device including the same hardware configuration as in the first embodiment, and the control program 17 is the same as that in the first embodiment, except for elements related to the measurement position adjustment process. Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the measurement position adjustment process.

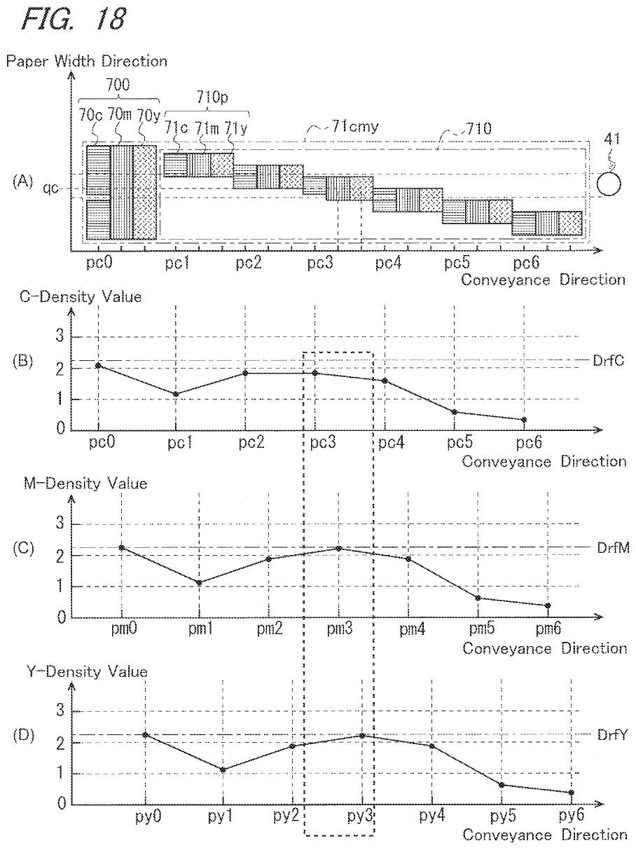

(A), (B), (C), and (D) of FIG. 18 are diagrams describing a measurement position detection method in the present embodiment. In the present embodiment, each patch 710p of the detection pattern 710 consists of a plurality of subpatches of different colors, and correspondingly, the reference pattern consists of a plurality of subpatterns whose colors corresponding to the respective colors of the subpatches in the patch 710p. This allows the measurement position adjustment process to detect the measurement position even if there is any discharge failure of the ink discharge heads within the recording portion 223. (A) of FIG. 18 illustrates a measurement position detection chart 71cmy in the present embodiment. In the example shown in (A) of FIG. 18, the reference pattern 700 consists of a C-subpattern 70c in cyan, an M-subpattern 70m in magenta, and a Y-subpattern 70y in yellow, which are arranged sequentially in the conveyance direction. Also, in the detection pattern 710, each patch 710p consists of a C-subpatch 71c in cyan, an M-subpatch 71m in magenta, and a Y-subpatch 71y in yellow, which are arranged sequentially in the conveyance direction. In the paper width direction, each of the three subpatterns 70c, 70m, and 70y within the reference pattern 700 has the same dimension as the reference pattern 700 in the measurement position detection chart 71 used in the first embodiment ((A) of FIG. 10). Moreover, in the paper width direction, each of the three subpatches 71c, 71m, and 71y within each patch 710p of the detection pattern 710 has the same dimension as the patch 710p of the detection pattern 710 within the measurement position detection chart 71 used in the first embodiment ((A) of FIG. 10). As shown in (A) of FIG. 18, the patches 710p of the detection pattern 710 in the present embodiment, similar to those in the first embodiment, are arranged in the conveyance direction while deviating from one another in the paper width direction within the range defined by the reference pattern 700 in the paper width direction.

Unlike the monochrome (black) measurement position detection charts 71 and 72 used in the measurement position adjustment processes (see FIGS. 9 and 13) in the first and second embodiments, the measurement position detection chart 71cmy in the present embodiment uses the three colors C, M, and Y, as shown in (A) of FIG. 18 (referred to below as the “CMY measurement position detection chart”).

In the CMY measurement position detection chart 71cmy shown in (A) of FIG. 18, the C-, M-, and Y-subpatterns 70c, 70m, and 70y within the reference pattern 700 correspond to conveyance direction positions pc0, pm0, and py0, respectively. As for the detection pattern 710, the C-, M-, and Y-subpatches 71c, 71m, and 71y within the i′th patch 710p (where i=1 to 6) in the conveyance direction correspond to conveyance direction positions pci, pmi, and pyi, respectively. Accordingly, performing color measurements on the CMY measurement position detection chart 71cmy formed on the printing paper 5 results in colorimetric data containing C-, M-, and Y-reference density values DrfC, DrfM, and DrfY, which correspond to the conveyance direction positions pc0, pm0, and py0, respectively. Furthermore, for each patch 710p, the colorimetric data contains C-, M-, and Y-density values DpCi, DpMi, and DpYi (where i=1 to 6) corresponding to the conveyance direction positions pci, pmi, and pyi, respectively. More specifically, the colorimetric data contains detection pattern density values as represented by C-density values DpC1 to DpC6 respectively corresponding to conveyance direction positions pc1 to pc6, M-density values DpM1 to DpM6 respectively corresponding to conveyance direction positions pm1 to pm6, and Y-density values DpY1 to DpY6 respectively corresponding to conveyance direction positions py1 to py6 (see (B) of FIG. 18 to (D) of FIG. 18). Note that for each color, the subpattern 70x and the subpatch 71x (where x=c, m, y) are assumed to be recorded on the printing paper 5 at the same density.

### 4.1 First Configuration Example

In this configuration example, the CMY measurement position detection chart 71cmy shown in (A) of FIG. 18 is used in the measurement position adjustment process of the first embodiment (FIG. 9), in place of the measurement position detection chart 71 shown in (A) of FIG. 10. In this case, for the C-, M-, and Y-density values DpCk, DpMk, and DpYk (where k is an integer of 1≤k≤6) at the conveyance direction positions pck, pmk, and pyk, which correspond to the C-, M-, and Y-subpatches 71c, 71m, and 71yc, respectively, within each patch 710p of the detection pattern 710, when at least two of these three density values are determined to be equal to their respectively corresponding ones of the C-, M-, and Y-reference density values DrfC, DrfM, and DrfY (more precisely, to be equal within a predetermined error range) at step S140 in FIG. 9, all three density values of the each patch 710p are regarded as equal to their respective reference density values, and hence the each patch 710p is regarded as having a density-to-reference-value match for the conveyance direction position. Then, the paper width direction position qk of the each patch 710p is determined as the current measurement position qc (i.e., the measurement position of the colorimeter 64 at that specific time or the paper width direction position of the reading spot 41) at step S145 in FIG. 9. Further, at step S150, the measurement position deviation amount Δq is calculated such that Δq=qk−qn. Note that the position qn is a predetermined appropriate measurement position for the colorimeter 64 to perform color measurements on the color chart 53. In the present embodiment also, the appropriate measurement position qn is the center position of the reference pattern 700 in the paper width direction.

Here, consider the case where the colorimeter 64 performs color measurements on the CMY measurement position detection chart 71cmy on the printing paper 5 at the reading spot 41 following a path as represented by two parallel dotted lines in (A) of FIG. 18. In this case, among the C-, M-, and Y-density values DpC3, DpM3, and DpY3 at the conveyance direction positions pc3, pm3, and py3, which correspond to the C-, M-, and Y-subpatches 71c, 71m, and 71yc, respectively, within the patch 710p located substantially in its entirety within the path of the reading spot 41 (i.e., the third patch 710p from the left in the figure), the M- and Y-density values DpM3 and DpY3 are generally equal to the M- and Y-reference density values DrkM and DrfY (i.e., equal to the M- and Y-reference density values DrkM and DrfY within the predetermined error range), respectively. However, the C-density value DpC3 essentially differs from the C-reference density value DrfC due to any discharge failure (nozzle failure) of the ink discharge heads within the recording portion 223. Nevertheless, in the present embodiment, even in this case, all three density values are regarded as equal to their respective reference density values, and hence the entire third patch 710p is regarded as having a density-to-reference-value match for the conveyance direction position.

Accordingly, in the present embodiment, even with any discharge failure of the ink discharge heads within the recording portion 223, the measurement position adjustment process using the CMY measurement position detection chart 71cmy allows for accurate detection of the current measurement position qc (the paper width direction position of the reading spot 41) and adjustments to the paper width direction position of the colorimeter 64 in accordance with the measurement position deviation amount Δq=qk−qn. Thus, even with the occurrence of any discharge failure of the ink discharge heads within the recording portion 223, the first configuration example of the present embodiment ensures effects similar to those achieved in the first embodiment.

### 4.2 Second Configuration Example

The CMY measurement position detection chart 71cmy may be used in the measurement position adjustment process of the second embodiment (FIG. 13), in place of the measurement position detection chart 71 shown in (A) and (C) of FIG. 12, and (A) and (C) of FIG. 14. In this case, for the C-, M-, and Y-density values DpCk, DpMk, and DpYk (where k is an integer of 1≤k≤6) at the conveyance direction positions pck, pmk, and pyk, which correspond to the C-, M-, and Y-subpatches 71c, 71m, and 71yc, respectively, within each patch 710p of the detection pattern 710, when at least two of these three density values are determined to generally equal (more precisely, equal within the predetermined error range) to their respectively corresponding ones of the C-, M-, and Y-reference density values DrfC, DrfM, and DrfY at step S121 in FIG. 13, all three density values of that patch 710p are regarded as equal to their respective reference density values, and hence the each patch 710p is regarded as having a density-to-reference-value match for the conveyance direction position. Such a determination is made for each patch 710p within the detection pattern 710. If the determination results for any patches 710p indicate no density-to-reference-value matches for their respective conveyance direction positions, the procedure advances to step S122. Conversely, if the determination result for any one specific patch 710p indicates a density-to-reference-value match for the conveyance direction position, the procedure advances to step S140.

At step S122, the recording portion 223 and the conveyance mechanism are controlled to form a new YMC color measurement detection chart 7lymc on the printing paper 5 with the patches 710p deviating from one another in the paper width direction by a reduced amount. Thereafter, the procedure returns to step S120.

At step S140, the any one specific patch 710p is determined to be situated at the any one conveyance direction position pk. At step S145, the paper width direction position qk of the any one specific patch 710p is determined as the current measurement position qc (i.e., the paper width direction position of the reading spot 41). Thereafter, a similar processing sequence to that in the first configuration example (steps S150 to S170) is executed.

In the second configuration example of the present embodiment, even with the occurrence of any discharge failure of the ink discharge heads within the recording portion 223, the current measurement position qc is accurately detected, ensuring effects similar to those achieved in the second embodiment.

### 4.3 Other Configuration Examples

As in the first and second embodiments, the CMY measurement position detection chart 71cmy can also be used in the third embodiment. Moreover, the CMY measurement position detection chart 71cmy can be used in other embodiments as well, so long as such use aligns with the spirit of the present invention without causing contradictions. Note that instead of using the CMY measurement position detection chart 71cmy, a similarly configured measurement position detection chart may be used, with both the reference pattern and the patches of the detection pattern using three colors other than C, M, and Y or even four or more colors.

### 5. Fifth Embodiment

Described next is a printing device 10 according to a fifth embodiment of the present invention. This printing device 10 is also an inkjet printing device including the same hardware configuration as in the first embodiment, and the control program 17 is the same as that in the first embodiment, except for elements related to a patch size detection process to be described later. Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the patch size detection process.

In the printing device 10, when the printing paper 5 is replaced with new printing paper 5, the size of the patches 710p used for the measurement position detection chart 71 might need to be changed due to variations in the distance to the colorimeter 64 caused by the thickness of the new printing paper 5, reflections from unprinted areas around the measurement position, and other factors. In such a case, the present embodiment executes the patch size detection process.

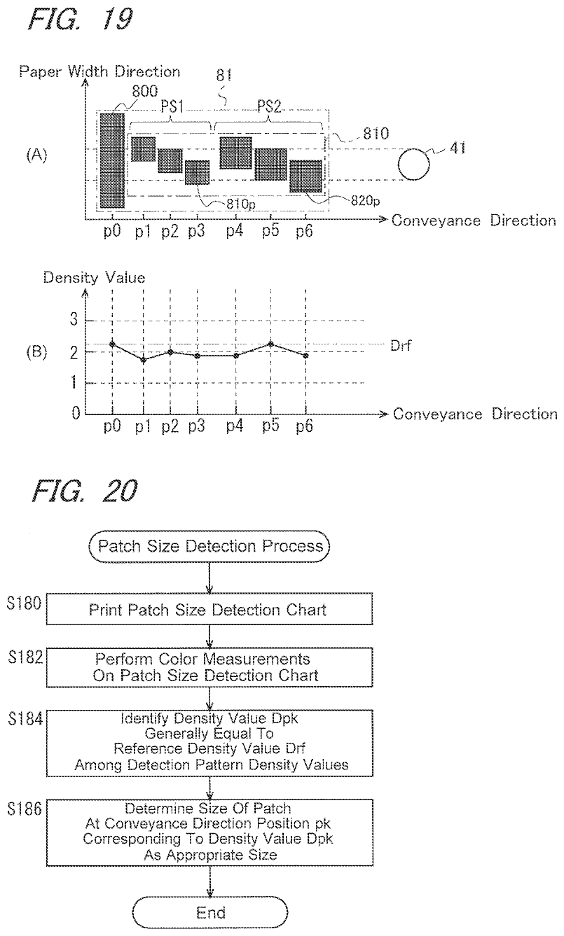

(A) and (B) of FIG. 19 are diagrams describing the patch size detection process, where an appropriate patch size for measurement position detection is determined using the measurement position detection chart. FIG. 20 is a flowchart showing the procedure of the patch size detection process. The patch size detection process may be either independent or part of the measurement position adjustment process. In the patch size detection process, the CPU 111 operates as follows.

Initially, the recording portion 223, serving as the printhead, and the conveyance mechanism are controlled to form a patch size detection chart 81, as shown in (A) of FIG. 19, on the printing paper 5 (step S180). The patch size detection chart 81 has basically the same configuration as the measurement position detection chart 71 and consists of a reference pattern 800 and a detection pattern 810. The detection pattern 810 includes a first patch array PS1 and a second patch array PS2. The first patch array PS1 consists of a plurality of square patches 810p arranged in the conveyance direction while deviating from one another in the paper width direction. The second patch array PS2 is disposed downstream from the first patch array PS1 in the conveyance direction and similarly consists of a plurality of square patches 820p arranged in the conveyance direction while deviating from one another in the paper width direction. In the first patch array PS1, the length of each side of the patches 810p is shorter than the size or diameter of the reading spot 41 of the colorimeter 64. In the second patch array PS2, each side of the patch 820p is slightly longer than that of the patch 810p in the first patch array PS1. While the detection pattern 810 consists of the two patch arrays PS1 and PS2 in the example shown in (A) of FIG. 19, the detection pattern 810 may consist of three or more patch arrays that increase in size toward the downstream in the conveyance direction.

Once the patch size detection chart 81 as described above is formed on the printing paper 5, the colorimeter 64 and the conveyance mechanism are controlled such that the colorimeter 64 performs color measurements on the patch size detection chart 81 (step S182). This results in colorimetric data consisting of density values outputted as colorimetric values by the colorimeter 64. The density values in the colorimetric data include a reference density value Drf, resulting from color measurements on the reference pattern 800, and detection pattern density values Dp1 to Dp6, resulting from color measurements at conveyance direction positions p1 to p6, respectively, which correspond to the centers of the patches 810p and 820p within the detection pattern 810. (B) of FIG. 19 represents these density values in the colorimetric data using a line graph.

Next, the density value Dpk that is generally equal to the reference density value Drf (i.e., equal to the reference density value Drf within a predetermined error range) is identified among the detection pattern density values Dp1 to Dp6 in the colorimetric data (step S184). In the example shown in FIG. 19, the length of each side of the patches 810p in the first patch array PS1 is shorter than the size or diameter of the reading spot 41, and therefore the density values Dp1 to Dp3 corresponding to the conveyance direction positions p1 to p3 are all smaller than the reference density value Drf. On the other hand, the length of each side of the patches 820p in the second patch array PS2 is approximately equal to the size or diameter of the reading spot 41, and therefore, among the density values Dp4 to Dp6 corresponding to the conveyance direction positions p4 to p6, the density value Dp5 is generally equal to the reference density value Drf.

Next, the patch 820p at the conveyance direction position pk corresponding to the density value Dpk that is generally equal to the reference density value Drf (in the example shown in FIG. 19, Dp5) is determined to be appropriate in patch size for the measurement position detection chart (step S186), and then the patch detection process ends.

In the present embodiment, the patch size detection process determines the appropriate patch size for the measurement position detection chart, as described above, and therefore the measurement position adjustment process can use the measurement position detection chart 71 that includes such appropriately sized patches. This allows for efficient detection of the measurement position of the colorimeter 64 (i.e., the paper width direction position of the reading spot 41) in the measurement position adjustment process.

It should be noted that when the patch size detection process constitutes a part of the measurement position adjustment process, steps S180 and S182 described above are implemented as steps S110 and S120 in the measurement position adjustment process (FIG. 17) using the patch size detection chart 81 as shown in (A) of FIG. 19 in place of the measurement position detection chart 71.

### 6. Sixth Embodiment

Described next is a printing device 10 according to a sixth embodiment of the present invention. This printing device 10 is also an inkjet printing device including the same hardware configuration as in the first embodiment, and the control program 17 is the same as that in the first embodiment, except for elements related to the measurement position adjustment process. Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the measurement position adjustment process.

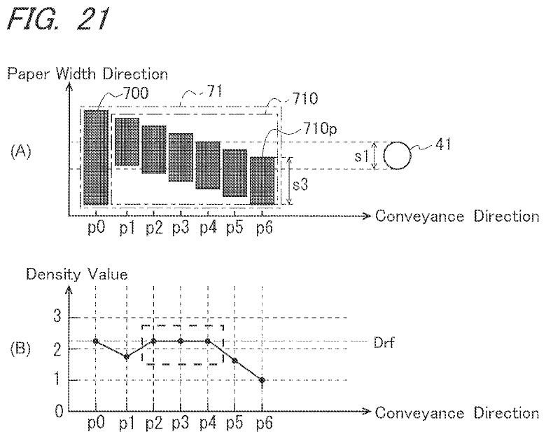

In some cases, when the measurement position adjustment process in the first embodiment (FIG. 9) uses the measurement position detection chart 71 with the patches being relatively large in the paper width direction, more than one of the detection pattern density values, such as those denoted by Dp1, Dp2, etc., might be generally equal to the reference density value Drf (i.e., equal to the reference density value Drf within a predetermined error range). For example, when the measurement position detection chart 71 is as shown in (A) of FIG. 21, the measurement position adjustment process in the first embodiment (FIG. 9) results in colorimetric data containing density values Dp1 to Dp6, as shown in (B) of FIG. 21. More specifically, in the measurement position detection chart 71 shown in (A) of FIG. 21, each patch 710p within the detection pattern 710 has a larger dimension in the paper width direction than the size or diameter of the reading spot 41, and therefore, among the detection pattern density values Dp1 to Dp6, the density values Dp2, Dp3, and Dp4, which correspond to the conveyance direction positions p2, p3, and p4, are all generally equal to the reference density value Drf (i.e., all equal to the reference density value Drf within the predetermined error range). Even in such a case, the measurement position adjustment process in the present embodiment can accurately detect the current measurement position qc (i.e., the paper width direction position of the reading spot 41).

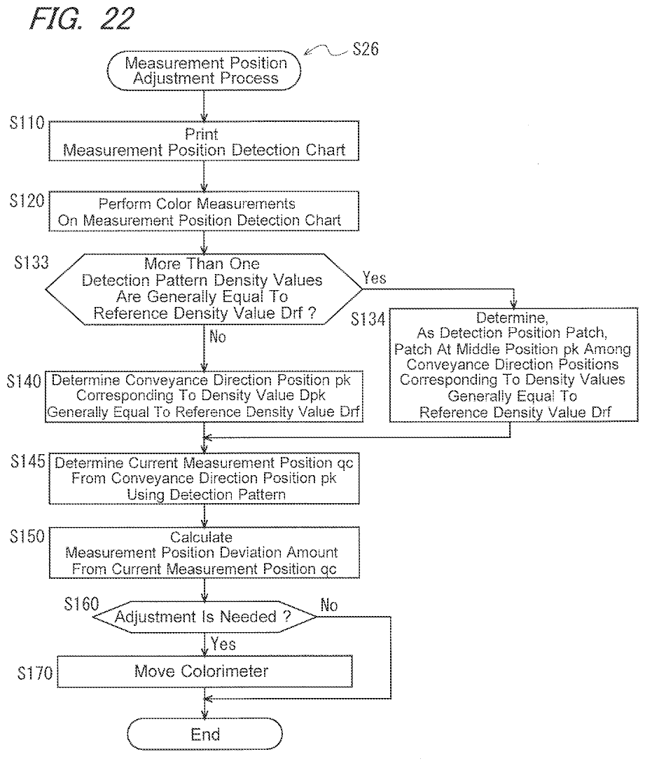

FIG. 22 is a flowchart showing the procedure of the measurement position adjustment process in the present embodiment. This measurement position adjustment process will be described below with reference to FIG. 22, along with FIG. 21. In the present embodiment, steps of the measurement position adjustment process (FIG. 22) that are the same as or correspond to those in the first embodiment (FIG. 9) are denoted by the same step numbers and will not be elaborated upon.

In the measurement position adjustment process in the present embodiment (FIG. 22), the CPU 111 in the printing control device 100 operates as will be described below. It is assumed below that each patch 710p within the measurement position detection chart 71 has a dimension s3 in the paper width direction larger than the size or diameter s1 of the reading spot 41 of the colorimeter 64. For the sake of convenience, it is also assumed below that the measurement position detection chart 71 includes six patches 710p as shown in (A) of FIG. 21, but the measurement position detection chart 71 may include seven or more patches 710p.

As shown in FIG. 22, the measurement position detection chart 71 ((A) of FIG. 21) is formed on the printing paper 5, and color measurements are performed on the measurement position detection chart 71, resulting in colorimetric data containing detection pattern density values Dp1 to Dp6, which correspond to conveyance direction positions p1 to p6 of the patches (steps S110 and S120). Then, it is determined whether more than one of the detection pattern density values Dp1 to Dp6 are generally equal to the reference density value Drf (i.e., equal to the reference density value Drf within the predetermined error range) (step S133).

When the determination result indicates that more than one of the detection pattern density values Dp1 to Dp6 are generally equal to the reference density value Drf, the procedure advances to step S134. For example, if the density values Dp2, Dp3, and Dp4 are generally equal to the reference density value Drf, as shown in (A) of FIG. 21, the patch 710p at the position pk located in the middle of the conveyance direction positions p2, p3, and p4 corresponding to the density values Dp2, Dp3, and Dp4, i.e., the patch 710p at p3, is determined as the detection position patch. Thereafter, the procedure advances to step S145.

When the determination result at step S133 indicates that only one of the detection pattern density values Dp1 to Dp6 is generally equal to the reference density value Drf, the procedure advances to step S140 to identify the conveyance direction position pk corresponding to that density value Dpk generally equal to the reference density value Drf. From the identified conveyance direction position pk, the current measurement position qc is determined with reference to the detection pattern 710 (step S145). Specifically, by identifying the patch 710p at the conveyance direction position pk as the detection position patch, the paper width direction position of the detection position patch is determined as the current measurement position qc. Thereafter, the procedure advances to step S150.

At and after step S150, similar to the measurement position adjustment process in the first embodiment (step S150 to step S170 in FIG. 9), the measurement position deviation amount Δq is calculated for the current measurement position (i.e., the paper width direction position of the reading spot 41) such that Δq=qc−qn, and the paper width direction position of the colorimeter 64 is adjusted in accordance with the measurement position deviation amount Δq.

The present embodiment allows for accurate detection of the current measurement position qc even if more than one of the detection pattern density values are generally equal to the reference density value Drf due to each patch within the measurement position detection chart 71 having a large dimension in the paper width direction.

It should be noted that when it is determined at step S133 that more than one of the detection pattern density values Dp1 to Dp6 are generally equal to the reference density value Drf (i.e., equal to the reference density value Drf within the predetermined error range), a step substituting step S134 may be executed before the procedure returns to step S120. This step controls the recording portion 223 and the conveyance mechanism to form a new measurement position detection chart 72 on the printing paper 5 with each patch 710p having a slightly reduced dimension in the paper width direction while leaving the size of the reference pattern 700 unchanged. With this configuration, the current measurement position qc can be detected using the measurement position detection chart, with the patches 710p appropriately sized as a result of stepwise patch size reduction to ensure that only one of the detection pattern density values Dp1 to Dp6 is generally equal to the reference density value Drf (i.e., equal to the reference density value Drf within the predetermined error range).

### 7. Seventh Embodiment

Described next is a printing device 10 according to a seventh embodiment of the present invention. This printing device 10 is also an inkjet printing device including the same hardware configuration as in the first embodiment, and the control program 17 is the same as that in the first embodiment, except for elements related to the measurement position adjustment process. Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the measurement position adjustment process.

In the first through third embodiments, the detection pattern density values, such as those denoted by Dp1, Dp2, Dp3, etc., correspond to the respective conveyance direction positions, such as those denoted by p1, p2, p3, etc., at the centers of the patches 710p (also referred to below simply as the “patch positions”) within the detection pattern 710 of the measurement position detection chart 71. Among these detection pattern density values, the density value Dpk that is generally equal to the reference density value Drf (i.e., equal to the reference density value Drf within a predetermined error range) is identified. The patch at the conveyance direction position pk that corresponds to the density value Dpk (i.e., the conveyance direction detection position) is identified as the detection position patch. The paper width direction position of the detection position patch is then determined as the current measurement position qc (i.e., the measurement position of the colorimeter 64 at that time) to be detected using the measurement position detection chart 71.

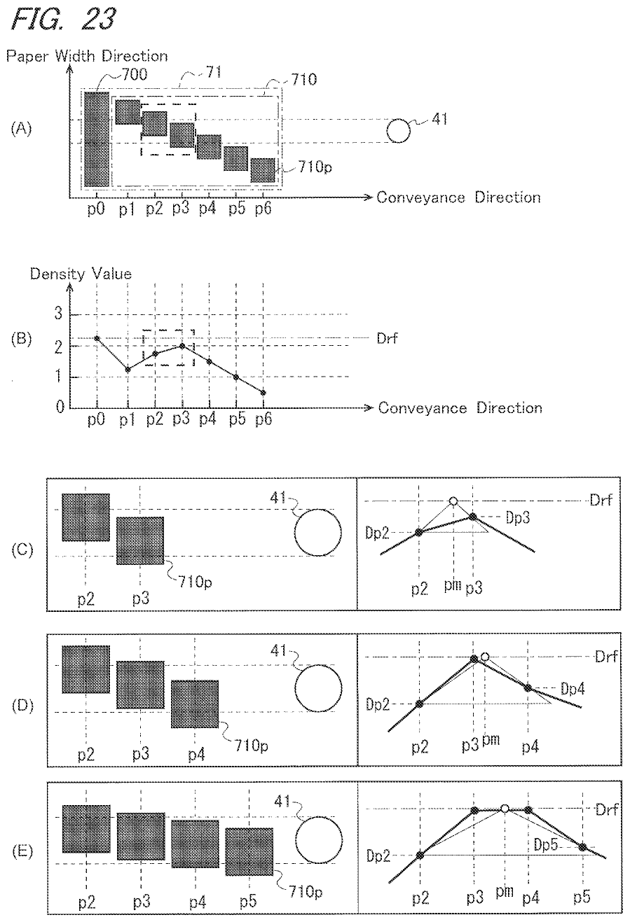

On the other hand, in the present embodiment, the current measurement position qc is determined as will be described below. The method for detecting the measurement position in the present embodiment will be described below with reference to (A), (B), (C), (D), and (E) of FIG. 23.

Consider now the case where a measurement position detection chart 71 as shown in (A) of FIG. 23 is formed on the printing paper 5, and the colorimeter 64 performs color measurements on the measurement position detection chart 71, resulting in colorimetric data as shown in (B) of FIG. 23. The colorimetric data contains detection pattern density values Dp1 to Dp6, assumed as functions D(p) relative to conveyance direction positions p. In the example outlined by (A) and (B) of FIG. 23, none of the detection pattern density values Dp1 to Dp6, which correspond to patch positions p1 to p6, respectively, are generally equal to the reference density value Drf (i.e., equal to the reference density value Drf within the predetermined error range). In this case, focusing on the density values Dp2 and Dp3 corresponding to the patch positions p2 and p3, i.e., the two closest of the density values Dp1 to Dp6 to the reference density value Drf, the conveyance direction position that satisfies the condition D(pm)=Drf is determined as the conveyance direction detection position pm based on the density values Dp2=D(p2) and Dp3=D(p3), as shown in (C) of FIG. 23. To elaborate, considering the differences ΔDp2 and ΔDp3 between the reference density value and the density values Dp2 and Dp3, i.e., ΔDp2=Drf−Dp2 and ΔDp3=Drf−Dp3, the conveyance direction detection position pm is determined as an internal point between the two conveyance direction positions p2 and p3, specifically at a ratio of ΔDp2:ΔDp3. The conveyance direction detection position pm can be deemed to correspond to the current measurement position qc (i.e., the measurement position of the colorimeter 64 at that specific time or the paper width direction position of the reading spot 41) by means of the detection pattern 710.

Furthermore, in the present embodiment, when only the density value Dp3, among the detection pattern density values Dp1 to Dp6 contained in the colorimetric data obtained as described above, is generally equal to the reference density value Drf (i.e., equal to the reference density value Drf within the predetermined error range), as shown in (D) of FIG. 23, the density values Dp2 and Dp4 are focused upon. These values correspond to two patch positions p2 and p4 adjacent to the conveyance direction detection position p3 corresponding to the density value Dp3. Based on the density values Dp2=D(p2) and Dp4=D(p4), the conveyance direction position that satisfies the condition D(pm)=Drf is identified as the conveyance direction detection position qm. To elaborate, considering the differences ΔDp2 and ΔDp4 between the reference density value and the density values Dp2 and Dp4, i.e., ΔDp2=Drf−Dp2 and ΔDp4=Drf−Dp4, the conveyance direction detection position pm is determined as an internal point between the two conveyance direction positions p2 and p4, specifically at a ratio of ΔDp2:ΔDp4. This conveyance direction detection position pm can also be deemed to correspond to the current measurement position by means of the detection pattern 710.

Furthermore, in the present embodiment, when two density values Dp3 and Dp4, among the detection pattern density values Dp1 to Dp6 contained in the colorimetric data obtained as described above, are generally equal to the reference density value Drf (i.e., equal to the reference density value Drf within the predetermined error range), as shown in (E) of FIG. 23, the density values Dp2 and Dp5 are focused upon. These values respectively correspond to two positions p2 and p5 adjacent to the conveyance direction detection positions p3 and p4 corresponding to the density values Dp3 and Dp4. Based on the density values Dp2=D(p2) and Dp5=D(p5), the conveyance direction position that satisfies the condition D(pm)=Drf is identified as the conveyance direction detection position qm. To elaborate, considering the differences ΔDp2 and ΔDp5 between the reference density value and the density values Dp2 and Dp5, i.e., ΔDp2=Drf−Dp2 and ΔDp5=Drf−Dp5, the conveyance direction detection position pm is determined as an internal point between the two conveyance direction positions p2 and p5, specifically at a ratio of ΔDp2:ΔDp5. This conveyance direction detection position pm can also be deemed to correspond to the current measurement position by means of the detection pattern 710.

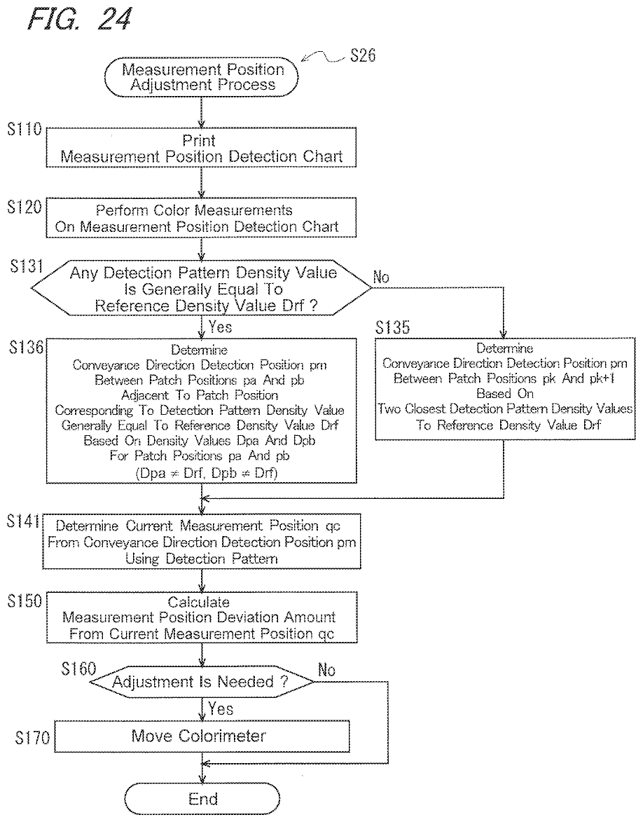

FIG. 24 is a flowchart showing the procedure of the measurement position adjustment process in the present embodiment. This measurement position adjustment process will be described below with reference to FIG. 24, along with FIG. 23. In the present embodiment, steps of the measurement position adjustment process (FIG. 24) that are the same as or correspond to those in the first embodiment (FIG. 9) are denoted by the same step numbers and will not be elaborated upon. In the measurement position adjustment process in the present embodiment (FIG. 24), the CPU 111 operates as follows.

As shown in FIG. 24, in the measurement position adjustment process in the present embodiment, color measurements are performed on the measurement position detection chart 71 formed on the printing paper 5, resulting in colorimetric data containing detection pattern density values, such as those denoted by Dp1, Dp2, Dp3, etc., which correspond to conveyance direction positions, such as those denoted by p1, p2, p3, etc., of the patches (step S120). Then, it is determined whether any of the detection pattern density values are generally equal to the reference density value Drf (i.e., equal to the reference density value Drf within the predetermined error range) (step S131).

When the determination result indicates that none of the detection pattern density values are generally equal to the reference density value Drf, the procedure advances to step S135, to identify the conveyance direction detection position pm between patch positions pk and pk+1 based on the detection pattern density values Dpk and Dpk+1, which are the two closest of all the detection pattern density values to the reference density value Drf. More specifically, considering the differences ΔDpk and ΔDpk+1 between the reference density value and the density values Dpk and Dpk+1, i.e., ΔDpk=Drf−Dpk and ΔDpk+1=Drf−Dpk+1, the conveyance direction detection position pm is determined as an internal point between the two conveyance direction positions pk and pk+1 at a ratio of ΔDpk:ΔDPk+1 (see (C) of FIG. 23).

When it is determined at step S131 that any one of the detection pattern density values is generally equal to the reference density value Drf (i.e., equal to the reference density value Drf within the predetermined error range), the procedure advances to step S136 to identify the conveyance direction detection position pm between two patch positions pa and pb adjacent to the patch position (conveyance direction position) that corresponds to the density value generally equal to the reference density value Drf, based on density values Dpa and Dpb corresponding to the patch positions pa and pb. More specifically, considering the differences ΔDpa and ΔDpb between the reference density value and the density values Dpa and Dpb, i.e., ΔDpa=Drf−Dpa and ΔDpb=Drf−Dpb, the conveyance direction detection position pm is determined as an internal point between the conveyance direction positions pa and pb at a ratio of ΔDpa:ΔDpb. Note that neither the density value Dpa nor Dpb is equal to the reference density value Drf. Here, pa=pk−1 and pb=pk+1 if only one of the detection pattern density values, i.e., Dpk, is generally equal to the reference density value Drf (see (D) of FIG. 23). Also, pa=pk−1 and pb=pk+2 if two of the detection pattern density values, i.e., Dpk and Dpk+1, are generally equal to the reference density value Drf (see (E) of FIG. 23).

Once the conveyance direction detection position pm is determined in the above manner at step S135 or S136, the paper width direction position that corresponds to the conveyance direction detection position pm is determined as the current measurement position qc (i.e., the measurement position of the colorimeter 64 at that specific time) (step S141). As shown in (A) of FIG. 23, the patches 710p in the detection pattern 710 are diagonally arranged at a predetermined slope relative to the conveyance direction, and therefore the paper width direction position that corresponds to the conveyance direction detection position pm can be determined as the current measurement position qc based on the slope. Moreover, when the conveyance direction detection position pm is determined at step S135, the measurement position may be determined as an internal point between the paper width direction positions qk and qk+1 of the patches 710p corresponding to their respective patch positions pk and pk+1 at a ratio of ΔDpk:ΔDpk+1. Alternatively, when the conveyance direction detection position pm is determined at step S136, the measurement position qc may be determined as an internal point between the paper width direction positions qa and qb of the patches 710p corresponding to their respective patch positions pa and pb at a ratio of ΔDpa:ΔDpb.

Next, the current measurement position qc as determined above is used to calculate a deviation amount from the appropriate measurement position qn for the colorimeter 64 to perform color measurements on the color chart 53, i.e., the measurement position deviation amount Δq=qc−qn (step S150).

Thereafter, similar to the measurement position adjustment process in the first embodiment (FIG. 9), the paper width direction position of the colorimeter 64 is adjusted in accordance with the measurement position deviation amount Δq (steps S160 and S170).

In the seventh embodiment, the conveyance direction detection position pm is not determined based on the detection pattern density value generally equal to the reference density value Drf (i.e., equal to the reference density value Drf within the predetermined error range), identified from among all the detection pattern density values. Instead, the conveyance direction detection position pm is determined based on the two closest detection pattern density values Dpk and Dpk+1 to the reference density value Drf (where Dpk≠Drf and Dpk+1≠Drf) or the density values Dpa and Dpb for the patch positions adjacent to the patch position or positions corresponding to the detection pattern density value Dpk or values Dpk and Dpk+1 generally equal to the reference density value Drf (see (C) of FIG. 23 to (E) of FIG. 23 and steps S135 and S136 in FIG. 24). From the conveyance direction detection position pm, the current measurement position qc (i.e., the measurement position of the colorimeter 64 at that specific time) is determined with reference to the detection pattern 710 (step S141). Thus, the current measurement position qc can be determined with relatively greater accuracy and less processing than in the preceding embodiments, ensuring effects similar to those achieved in the first embodiment.

It should be noted that in the present embodiment, the conveyance direction detection position pm can be considered as determined through interpolation based on two detection pattern density values, selected from among all detection pattern density values, that are closest to, but not generally equal (i.e., not equal within the predetermined error range) to, the reference density value Drf. However, the conveyance direction detection position pm may be determined through interpolation based on three or more such detection pattern density values from among all detection pattern density values.

### 8. Eighth Embodiment

Described next is a printing device 10 according to an eighth embodiment of the present invention. This printing device 10 is also an inkjet printing device including the same hardware configuration as in the first embodiment, and the control program 17 is the same as that in the first embodiment, except for elements related to an anti-meandering process to be described later. Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the anti-meandering process.

In the inkjet printing device 10 using a roll of printing paper 5, as shown in FIG. 2, the position of the printing paper 5 might deviate in a direction perpendicular to the conveyance direction of the printing paper 5 (simply referred to below as the “conveyance direction”) due to, for example, the execution of printing under various printing settings, changes in the condition of the conveyance path of the printing paper 5, or the shrinkage of the printing paper 5 after drying through a dryer mechanism. Accordingly, maintaining stable color measurements becomes difficult after the position of the colorimeter 64 is adjusted. For example, even if the position of the colorimeter 64 is adjusted immediately after the printing paper 5 is replaced, the position of the printing paper 5 might deviate significantly in the direction perpendicular to the conveyance direction while a large amount of printing is executed, leading to inaccurate colorimetric data. To deal with this problem, it is conceivable to increase the size of each patch included in the color chart 53 for color measurements. However, increasing the patch size of the color chart results in reduced areas for recording images (target print images) based on actual printing jobs. Therefore, in the present embodiment, the anti-meandering process is executed to deal with problems resulting from the meandering of the printing paper 5.

### 8.1 First Example of Anti-Meandering Process

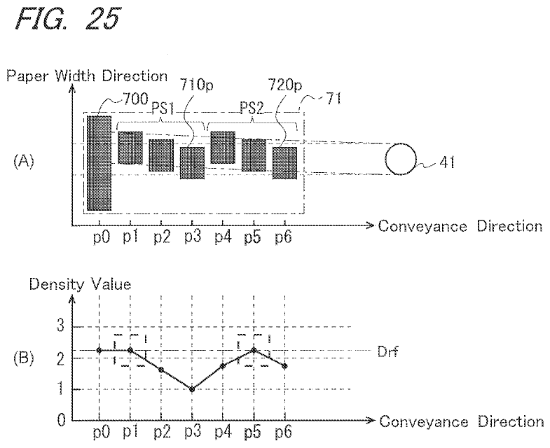

(A) and (B) of FIG. 25 are diagrams describing an approach for detecting the meandering of the printing paper 5 in a first example of the anti-meandering process in the present embodiment. This approach uses a measurement position detection chart 71, as shown in (A) of FIG. 25, serving as a meandering detection chart. Similar to typical measurement position detection charts as described earlier, this meandering detection chart 71 consists of the reference pattern 700 and the detection pattern 710. However, this meandering detection chart 71 differs in that the detection pattern 710 includes first and second patch arrays PS1 and PS2 sharing the same configuration. Both the first and second patch arrays PS1 and PS2 consist of a plurality of (in the example shown in (A) of FIG. 25, three) rectangular patches 710p or 720p arranged in the conveyance direction while deviating from one another in the paper width direction. The second patch array PS2 is disposed downstream from the first patch array PS1 in the conveyance direction. In the following, the patch 710p at the conveyance direction position pi within the first patch array PS1 will be denoted by the symbol “710p(pi)” (where i=1 to 3), and the patch 720p at the conveyance direction position pi within the second patch array PS2 will be denoted by the symbol “720p(pi)” (where i=4 to 6). These corresponding patches 710p(pi) and 720p(pi+3) between the first and second patch arrays PS1 and PS2 have the same size and are disposed at the same paper width direction position. Note that in the following also, the term “patch position” is used to refer to each of the conveyance direction positions p1 to p6.

When the colorimeter 64 performs color measurements on such a meandering detection chart 71 formed on the printing paper 5 while the printing paper 5 is being conveyed, the reading spot 41 of the colorimeter 64 follows a path, for example, as represented by two parallel dotted lines that tangent to the reading spot 41 in (A) of FIG. 25 unless the printing paper 5 is meandering. On the other hand, if the printing paper 5 is meandering, the reading spot 41 of the colorimeter 64 follows a path as represented by two parallel dash-dotted lines that tangent to the reading spot 41 in (A) of FIG. 25. In this case, the colorimeter 64 obtains colorimetric data containing detection pattern density values Dp1 to Dp6 (acquired as colorimetric values for the patch positions p1 to p6), as shown in (B) of FIG. 25. Since the patch 710p(p1) at the patch position p1 within the first patch array PS1 corresponds to the patch 720p(p4) at the patch position p4 within the second patch array PS2, the density value Dp1 for the patch position p1, from among the detection pattern density values Dp1 to Dp6, is equal to the density value Dp4 for the patch position p4 unless the printing paper 5 is meandering.

However, in the colorimetric data in (B) of FIG. 25, the density value Dp1 for the patch position p1 differs from the density value Dp4 for the patch position p4 due to the meandering of the printing paper 5, but is equal to the density value Dp5 for the patch position p5. Accordingly, in the present embodiment, each pair of corresponding patches between the two patch arrays PS1 and PS2 sharing the same configuration (in the example shown in (A) of FIG. 25, the patches 710p(pi) and 720p(pi+3) (where i=1 to 3)) is compared in terms of the density values Dpi and Dpi+3 for their respective patch positions pi and pi+3. If the difference between the density values Dpi and Dpi+3 exceeds a predetermined amount or tolerance value, the printing paper 5 is determined to be meandering. Note that in the meandering detection chart 71 shown in (A) of FIG. 25, the patch arrays PS1 and PS2 sharing the same configuration are arranged in the conveyance direction, but three or more patch arrays sharing the same configuration may be arranged in the conveyance direction.

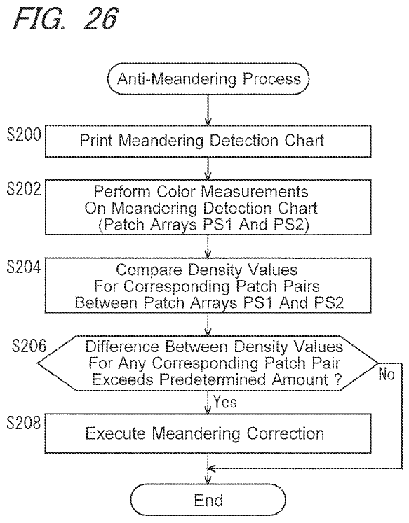

FIG. 26 is a flowchart showing the procedure of the first example of the anti-meandering process employing the meandering detection approach described above. The anti-meandering process may be independent or part of the measurement position adjustment process. The same applies to a second example of the anti-meandering process, which will be described later. In the present example of the anti-meandering process, the CPU 111 operates as will be described below. Note that, for the sake of convenience, the following descriptions assume the use of the meandering detection chart 71 shown in (A) of FIG. 25. However, the meandering detection chart may include three or more patch arrays, and each patch array may include four or more patches.

In the present example of the anti-meandering process, as shown in FIG. 26, the recording portion 223, serving as the printhead, and the conveyance mechanism are initially controlled to form the meandering detection chart 71, as shown in (A) of FIG. 25, on the printing paper 5 (step S200).

Next, the colorimeter 64 and the conveyance mechanism are controlled such that the colorimeter 64 performs color measurements on the meandering detection chart 71 (step S202). This results in colorimetric data containing density values outputted as colorimetric data by the colorimeter 64. Specifically, the colorimetric data contains a reference density value Drf, resulting from color measurements on the reference pattern 700, and detection pattern density values Dp1 to Dp6, resulting from color measurements at patch positions p1 to p6, respectively, which correspond to the centers of the patches 710p and 720p in the conveyance direction within the detection pattern 710. (B) of FIG. 25 represents these density values in the colorimetric data using a line graph.

Next, the patch arrays PS1 and PS2 are compared using the detection pattern density values Dp1 to Dp6 in the colorimetric data (step S204). More specifically, each pair of corresponding patches between the patch arrays PS1 and PS2 is compared in terms of the density values Dpi and Dpi+3 for their respective patch positions pi and pi+3 to determine the difference |Dpi−Dpi+3|(where i=1 to 3) between the density values Dpi and Dpi+3.

Thereafter, it is determined whether the calculated difference |Dpi−Dpi+3| between the density values exceeds a predetermined amount or tolerance value for any pair of corresponding patches between the patch arrays PS1 and PS2 (step S206).

When the determination results indicate that the difference |Dpi−Dpi+3| between the density values exceeds the predetermined amount for any patch pair, the procedure advances to step S208 to execute meandering correction, considering that the printing paper 5 is meandering. Specifically, while the printing paper 5 is being conveyed, the edge detection sensor 61 detects an edge position. Based on the detected edge position, along with the size of the printing paper 5, the meandering correction mechanism 62 adjusts the position of the printing paper 5 being conveyed. The meandering correction mechanism 62 may have any known or well-known configuration and can employ, for example, the configuration of the meandering correction portion described in Japanese Laid-Open Patent Publication No. 2021-54562. After the execution of such meandering correction, the anti-meandering process ends.

If the determination results at step S206 indicate, for all patch pairs, that the difference |Dpi−Dpi+3|(where i=1 to 3) between the density values is less than or equal to the predetermined amount, the anti-meandering process ends without executing meandering correction.

### 8.2 Second Example of Anti-Meandering Process

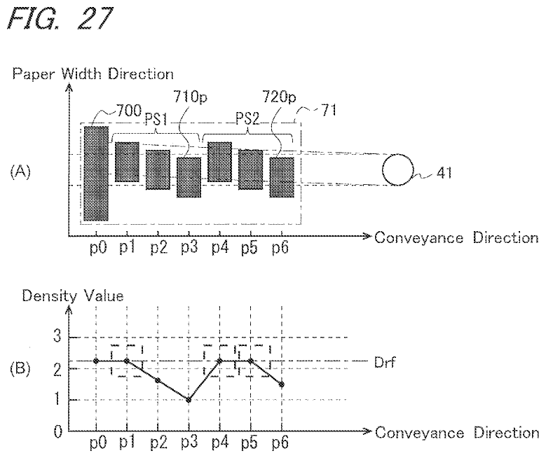

(A) and (B) of FIG. 27 are diagrams describing an approach employed in a second example of the anti-meandering process in the present embodiment. This approach uses a measurement position detection chart, as shown in (A) of FIG. 27, serving as a meandering detection chart 71. This meandering detection chart 71 has the same configuration as the meandering detection chart 71 in (A) of FIG. 25 used in the first example, and therefore the same or corresponding components are denoted by the same reference characters. However, in the meandering detection chart 71 shown in (A) of FIG. 27, the patches 710p and 720p are slightly larger in the paper width direction than those shown in (A) of FIG. 25. Moreover, in the present example of the anti-meandering process, the dimensions of the patches 710p and 720p in the paper width direction are changed as necessary upon printing of a new meandering detection chart, as will be described later.

When the colorimeter 64 performs color measurements on such a meandering detection chart 71 formed on the printing paper 5 while the printing paper 5 is being conveyed, the reading spot 41 of the colorimeter 64 follows a path as represented by two parallel dotted lines that tangent to the reading spot 41 in (A) of FIG. 27 unless the printing paper 5 is meandering. On the other hand, if the printing paper 5 is meandering, the reading spot 41 follows a path as represented by two parallel dash-dotted lines that tangent to the reading spot 41 in (A) of FIG. 27. When the meandering detection chart 71 shown in (A) of FIG. 25 is used, if the printing paper 5 is meandering, the difference between the density values Dpi and Dpi+3 for the patch positions pi and pi+3 might exceed the predetermined amount or tolerance value for any pair of corresponding patches between the two patch arrays PS1 and PS2, as described earlier (see (B) of FIG. 25).

However, when the meandering detection chart 71 shown in (A) of FIG. 27 is used, the dimensions of the patches 710p and 720p in the paper width direction are slightly larger than those in (A) of FIG. 25. Therefore, even if the printing paper 5 is meandering, the difference between the density values Dpi and Dpi+3 for the patch positions pi and pi+3 remains less than or equal to the predetermined amount or tolerance value for all pairs of corresponding patches between the two patch arrays PS1 and PS2. Accordingly, for the measurement position detection chart 71 shown in, for example, (A) of FIG. 10, appropriately increasing the dimension of each patch 710p in the paper width direction allows for accurate calculation of the measurement position deviation amount in the measurement position adjustment process, even if the printing paper 5 is meandering to some extent. Thus, the second example of the anti-meandering process in the present embodiment allows for the identification of an appropriate patch dimension in the paper width direction for the measurement position detection chart.

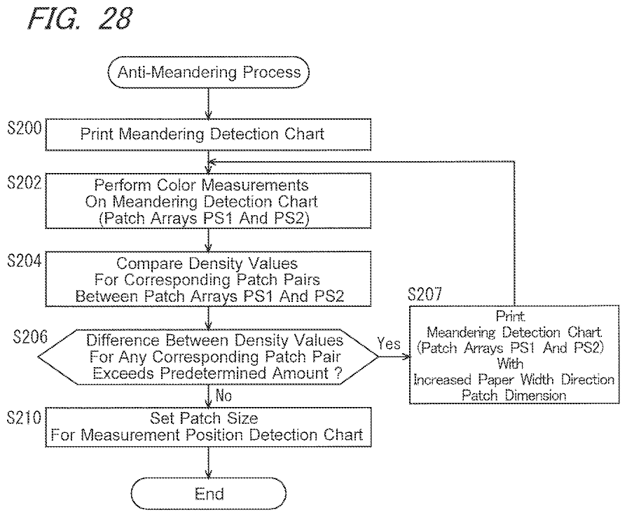

FIG. 28 is a flowchart showing the procedure of the second example of the anti-meandering process employing the approach described above. In the present example as well, the anti-meandering process may be independent or part of the measurement position adjustment process. In the following descriptions of the present example, steps of the measurement position adjustment process that are the same as or correspond to those in the first example of the anti-meandering process (FIG. 26) are denoted by the same step numbers and will not be elaborated upon.

In the present example of the anti-meandering process, the CPU 111 operates as will be described below. Note that, for the sake of convenience, the following descriptions assume the use of the meandering detection charts 71 as shown in (A) of FIG. 25 and (A) of FIG. 27. However, each meandering detection chart may include three or more patch arrays, and each patch array may include four or more patches.

In the present example of the anti-meandering process, as shown in FIG. 28, similar to the first example of the anti-meandering process (FIG. 26), color measurements are performed on the meandering detection chart 71 in (A) of FIG. 25 (steps S200 and S202), resulting in colorimetric data. The colorimetric data is then used to compare the density values Dpi and Dpi+3 for the patch positions pi and pi+3 of the pairs of corresponding patches between the patch arrays PS1 and PS2. For each pair, a determination is made as to whether the difference |Dpi−Dpi+3|(where i=1 to 3) between the density values Dpi and Dpi+3 exceeds a predetermined amount or tolerance value (steps S204 and S206).

In this example, when the determination results indicate that the difference |Dpi−Dpi+3| between the density values exceeds the predetermined amount for any pair of patches, the procedure advances to step S207 to control the recording portion 223 and the conveyance mechanism to form a new meandering detection chart 71 on the printing paper 5 with each of the patches 710p and 720p having a slightly increased dimension in the paper width direction (see (A) of FIG. 27). Thereafter, the procedure returns to step S202, and the sequence of steps S202, S204, S206, and S207 is repeated for colorimetric data resulting from color measurements on any new meandering detection chart 71 on the printing paper 5. This processing sequence continues until the differences |Dpi−Dpi+3|(where i=1 to 3) between the density values, calculated for all pairs of corresponding patches between the patch arrays PS1 and PS2, are determined to be less than or equal to the predetermined amount. In this processing sequence, when it is determined at step S206 that for colorimetric data obtained for any new meandering detection chart, the differences |Dpi−Dpi+3|(where i=1 to 3) between the density values, calculated for all pairs of corresponding patches, are determined to be less than or equal to the predetermined amount, the procedure advances to step S210.

At step S210, the dimension of each of the patches 710p and 720p in the paper width direction within the last meandering detection chart formed on the printing paper 5 at step S207 is determined as the dimension of each patch 710p in the paper width direction within the color position detection chart to be used for the subsequent measurement position adjustment process. Thereafter, the present example of the anti-meandering process ends.

### 8.3 Effects

In the eighth embodiment, the anti-meandering process, as outlined in FIG. 26 or 28, allows for the detection and correction of the meandering of the printing paper 5 (see step S208, etc., in FIG. 26), or allows for patch size determination for the measurement position detection chart, ensuring accurate calculation of the measurement position deviation amount, even if the printing paper 5 meanders to some extent (see step S207, etc., in FIG. 28). Thus, even if the printing paper 5 meanders, the current measurement position qc can be detected to appropriately adjust the position of the colorimeter 64.

### 9. Ninth Embodiment

Described next is a printing device 10 according to a ninth embodiment of the present invention. This printing device 10 is also an inkjet printing device including the same hardware configuration as in the first embodiment, and the control program 17 is the same as that in the first embodiment, except for elements related to a meandering amount detection process to be described later. Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the meandering amount detection process.

In the present embodiment, as in the eighth embodiment, some functions are included to deal with problems due to the meandering of the printing paper 5, but the meandering amount detection process is executed instead of the anti-meandering process in the eighth embodiment (FIGS. 26 and 28).

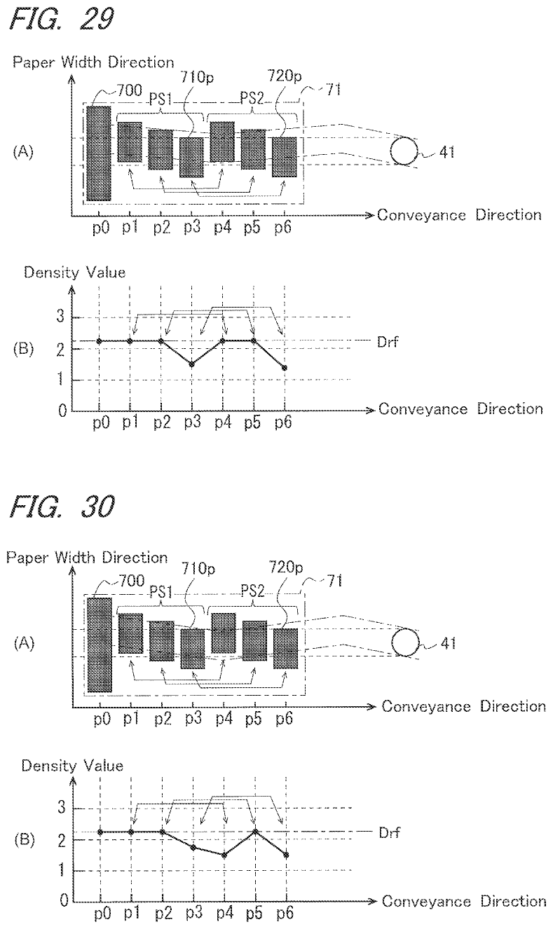

(A) and (B) of FIG. 29, and (A) and (B) of FIG. 30 are diagrams describing an approach for detecting the amount of meandering of the printing paper 5 in the meandering amount detection process. This approach uses a measurement position detection chart, as shown in (A) of FIG. 29, serving as a meandering amount detection chart 71. Similar to the measurement position detection charts described earlier, this meandering amount detection chart 71 consists of the reference pattern 700 and the detection pattern 710. Also, this meandering amount detection chart 71 has the same configuration as the meandering detection chart in the eighth embodiment shown in (A) of FIG. 27. That is, in this meandering amount detection chart 71 as well, the detection pattern 710 includes the first and second patch arrays PS1 and PS2 sharing the same configuration, and the second patch array PS2 is disposed downstream from the first patch array PS1 in the conveyance direction. Note that in the meandering amount detection chart 71 shown in (A) of FIG. 29, the two patch arrays PS1 and PS2 sharing the same configuration are arranged in the conveyance direction, but three or more patch arrays sharing the same configuration may be arranged in the conveyance direction.

When the colorimeter 64 performs color measurements on such a meandering amount detection chart 71 formed on the printing paper 5 while the printing paper 5 is being conveyed, the reading spot 41 of the colorimeter 64 follows a path, for example, as represented by two parallel dotted lines that tangent to the reading spot 41 in (A) of FIG. 29 unless the printing paper 5 is meandering.

On the other hand, if the printing paper 5 is meandering, the reading spot 41 of the colorimeter 64 follows a path as represented by two parallel dash-dotted lines that tangent to the reading spot 41 in (A) of FIG. 29. In this case, the colorimeter 64 obtains colorimetric data containing detection pattern density values as shown in (B) of FIG. 29. The patches 710p(p1), 710p(p2), and 710p(p3) within the first patch array PS1 correspond to the patches 720p(p4), 720p(p5), and 720p(p6), respectively, within the second patch array PS2. Accordingly, in the colorimetric data shown in (B) of FIG. 29, the density values Dpi and Dpi+3 for the positions pi and pi+3 of the three pairs of corresponding patches 710p(pi) and 720p(pi+3) (where i=1 to 3) between the first and second patch arrays PS1 and PS2 match each other and are generally equal to the reference density value Drf (i.e., equal to the reference density value Drf within a predetermined error range) unless the printing paper 5 is meandering.

However, if the printing paper 5 is meandering, whether the density values Dpi and Dpi+3 match each other and are generally equal to the reference density value for the three pairs of corresponding patches 710p(pi) and 720p(pi+3) (where i=1 to 3) between the first and second patch arrays PS1 and PS2 depends on the meandering amount of the printing paper 5. For example, when the meandering of the printing paper 5 causes the reading spot 41 to follow the path as represented by the two parallel dash-dotted lines that tangent to the reading spot 41 in (A) of FIG. 29, the density values Dp1 and Dp4 for the pair of patches 710p(p1) and 720p(p4) match each other and are generally equal to the reference density value Drf, as shown in (B) of FIG. 29. Similarly, the density values Dp2 and Dp5 for the pair of patches 710p(p2) and 720p(p5) match each other and are generally equal to the reference density value Drf. However, the density values Dp3 and Dp6 for the pair of patches 710p(p3) and 720p(p6) differ from each other.

(A) of FIG. 30 shows the same meandering amount detection chart 71 as that shown in (A) of FIG. 29. However, in (A) of FIG. 30, the path of the reading spot 41, represented by the two parallel dash-dotted lines that tangent to the reading spot 41, indicates a larger meandering amount of the printing paper 5 compared to the meandering amount of the printing paper 5 along the path of the reading spot 41 represented by the two parallel dash-dotted lines that tangent to the reading spot 41 in (A) of FIG. 29. In this case, the colorimeter 64 obtains colorimetric data as shown in (B) of FIG. 30. In this colorimetric data shown in (B) of FIG. 30, due to the meandering of the printing paper 5, the density values Dp2 and Dp5 for the pair of patches 710p(p2) and 720p(p5) match each other and are generally equal to the reference density value Drf. However, the density values Dp1 and Dp4 for the pair of patches 710p(p1) and 720p(p4) differ from each other. Similarly, the density values Dp3 and Dp6 for the pair of patches 710p(p3) and 720p(p6) differ from each other.

The above indicates that when the dimension of each of the patches 710p and 720p in the paper width direction and the measurement position of the colorimeter 64 (i.e., the paper width direction position of the reading spot 41) are appropriately set, the number of pairs of patches 710p(pk) and 720p(pk+3) for which the density values Dpk and Dpk+3 match each other and are generally equal to the reference density value Drf varies among the three pairs of corresponding patches 710p(pi) and 720p(pi+3) (where i=1 to 3) between the two patch arrays PS1 and PS2 in accordance with the meandering amount of the printing paper 5. Additionally, the number of such pairs of patches 710p(pk) and 720p(pk+3) decreases as the meandering amount increases.

FIG. 31 is a flowchart showing the procedure of the meandering amount detection process employing the approach described above. This meandering amount detection process may be independent or part of the measurement position adjustment process. In the present example of the anti-meandering process, the CPU 111 operates as will be described below. Note that, for the sake of convenience the following descriptions assume the use of the meandering amount detection chart 71 as shown in (A) of FIG. 29 and (A) of FIG. 30. However, the meandering amount detection chart may include three or more patch arrays, and each patch array may include four or more patches.

Initially, the recording portion 223, serving as the printhead, and the conveyance mechanism are controlled to form the meandering amount detection chart 71, as shown in (A) of FIG. 29 and (A) of FIG. 30, on the printing paper 5 (step S220).

Next, the colorimeter 64 and the conveyance mechanism are controlled such that the colorimeter 64 performs color measurements on the meandering amount detection chart 71 (step S222). This results in colorimetric data containing density values outputted as colorimetric values by the colorimeter 64. The density values in the colorimetric data include a reference density value Drf, resulting from color measurements on the reference pattern 700, and detection pattern density values Dp1 to Dp6, resulting from color measurements at patch positions p1 to p6, respectively, which correspond to the centers of the patches 710p and 720p in the conveyance direction within the detection pattern 710. (B) of FIG. 29 and (B) of FIG. 30 represent these density values in the colorimetric data using line graphs.

Next, the detection pattern density values Dp1 to Dp6 in the colorimetric data are used to compare the density values Dpi and Dpi+3 (where i=1 to 3) for the positions pi and pi+3 of each pair of corresponding patches 710p(pi) and 720p(pi+3) between the patch arrays PS1 and PS2 (step S224). These comparisons result in determining the number of pairs of patches 710p(pk) and 720p(pk+3) for which both the density values Dpk and Dpk+3 for the positions pk and pk+3 are generally equal to the reference density value Drf (step S226).

Thereafter, the meandering amount of the printing paper 5 is determined based on the number of pairs of patches 710p(pk) and 720p(pk+3) as obtained above (step S228). For example, the meandering amount can be determined based on the number of pairs of patches determined at step S226. The determination can be made with reference to a previously created table representing the correspondence between the meandering amount of the printing paper 5 and the number of pairs of patches for which the density values are generally equal to the reference density value Drf. This correspondence information is obtained in advance for the meandering amount detection chart 71 to be used, by temporarily using a means of meandering amount detection, such as an edge detection sensor.

After the meandering amount of the printing paper 5 is determined as described above, the meandering amount detection process ends.

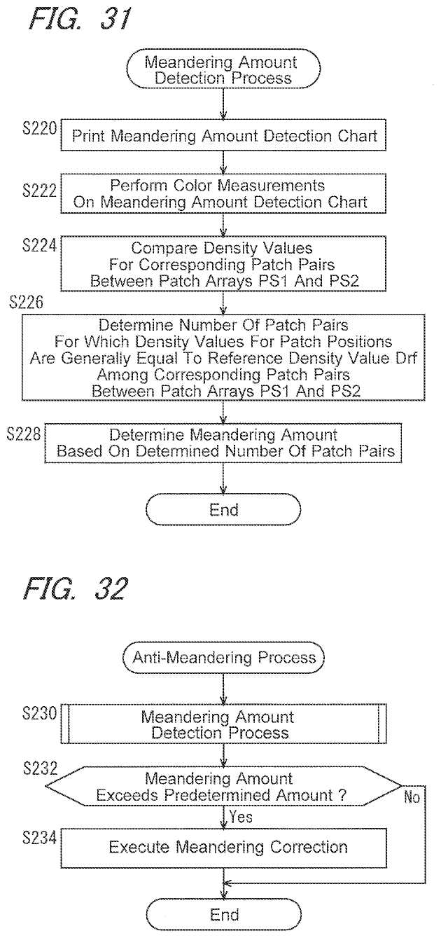

For example, the meandering amount determined by the meandering amount detection process as outlined in FIG. 31 can be used for correcting the meandering of the printing paper 5 like the anti-meandering process in the eighth embodiment as outlined in FIG. 26. FIG. 32 is a flowchart showing the procedure of an anti-meandering process incorporating the meandering amount detection process in FIG. 31. In this anti-meandering process, the CPU 111 operates as follows.

Initially, the meandering amount detection process in FIG. 31 is executed (step S230). Then, it is determined whether the meandering amount determined by the meandering amount detection process exceeds a predetermined amount or tolerance value (step S232).

When the determination result indicates that the meandering amount exceeds the predetermined amount, the procedure advances to step S234 to execute meandering correction, and then the anti-meandering process ends. Alternatively, if the determination result indicates that the meandering amount does not exceed the predetermined amount, the anti-meandering process ends without executing meandering correction.

In the present embodiment, as described above, the measurement position detection chart also serves as the meandering amount detection chart 71 as shown in, for example, (A) of FIG. 29. This enables the detection of the meandering amount of the printing paper 5 without using a sensor, and allows, for example, meandering correction based on the meandering amount as detected above.

### 10. Tenth Embodiment

Described next is a printing device 10 according to a tenth embodiment of the present invention. This printing device 10 is also an inkjet printing device including the same hardware configuration as in the first embodiment and having the same features as in the first embodiment, except for the configuration of the measurement position detection chart used in the measurement position adjustment process. Therefore, components of the printing device 10 according to the present embodiment that are the same as or correspond to those in the first embodiment are denoted by the same reference characters and will not be elaborated upon (see FIGS. 1 to 5 and 8). The present embodiment will be described below, mainly focusing on the configuration of the measurement position detection chart used in the measurement position adjustment process of the present embodiment.

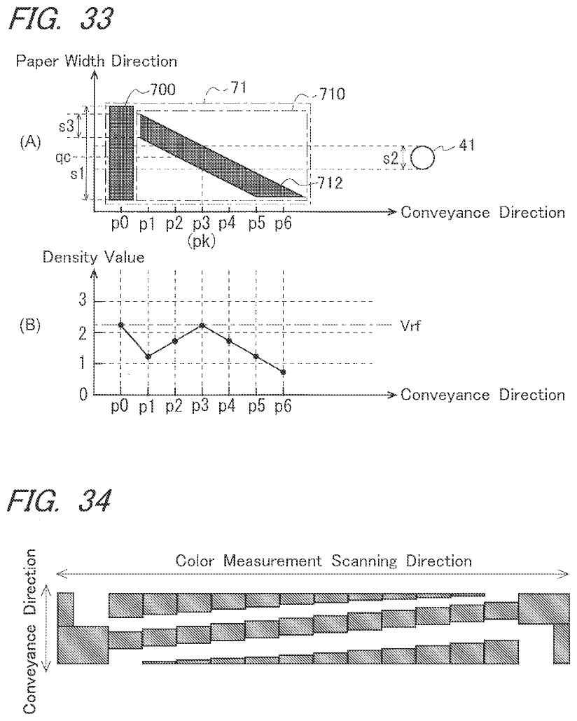

(A) and (B) of FIG. 33 are diagrams describing a method for detecting the current measurement position qc (the measurement position of the colorimeter 64 at that specific time or the paper width direction position of the reading spot 41 at that specific time) using the measurement position adjustment process of the present embodiment. This method uses a measurement position detection chart 71 as shown in (A) of FIG. 33. Similar to the measurement position detection chart 71 of the first embodiment ((A) of FIG. 10), this measurement position detection chart 71 consists of the reference pattern 700 and the detection pattern 710, but differs in the configuration of the detection pattern 710. Specifically, in the measurement position detection chart 71 of the first embodiment, the detection pattern 710 includes the rectangular patches 710p, as shown in (A) of FIG. 10. However, in the measurement position detection chart of the present embodiment, the detection pattern 710 consists of only one linear pattern 712 with a predetermined width, extending obliquely relative to the conveyance direction, as shown in (A) of FIG. 33. The linear pattern 712 preferably has a width s3 in the paper width direction wider than the dimension s1 of the reading spot 41 in the paper width direction, but this is not limiting. Note that the reference pattern 700 and the linear pattern 712, serving as the detection pattern 710, are recorded in the same color on the printing paper 5, and this implies that the recording of the reference pattern 700 and the linear pattern 712 is performed at the same density.

The colorimeter 64 performs color measurements on the measurement position detection chart 71, as shown in (A) of FIG. 33, on the printing paper 5, resulting in colorimetric data as shown in (B) of FIG. 33. Note that when the colorimeter 64 performs color measurements on the measurement position detection chart 71 while the printing paper 5 is being conveyed, the reading spot 41 of the colorimeter 64 follows a path as represented by two parallel dotted lines that tangent to the reading spot 41 in (A) of FIG. 33. Further, in (B) of FIG. 33, p0 represents the position of the center of the reference pattern 700 in the conveyance direction, and p1 to p6 correspond to the respective conveyance direction positions of the centers of the patches 710p in the detection pattern 710 within the measurement position detection chart 71 of the first embodiment. Note that in the measurement position detection chart 71 shown in (A) of FIG. 33, since the detection pattern 710 consists of the continuous linear pattern 712, conveyance direction measurement positions where detection pattern density values are obtained as colorimetric data (i.e., conveyance direction positions pi and pi+1 shown in (B) of FIG. 33, where i=1, 2, 3, . . . ) are simply required to be set within a range defined by the linear pattern 712 in the conveyance direction and therefore can be spaced apart at narrower intervals.

As can be appreciated from the measurement position detection chart 70 and the colorimetric data shown in (A) and (B) of FIG. 33, the measurement position of the colorimeter 64 at that specific time (i.e., the paper width direction position of the reading spot 41) can be determined as the current measurement position qc with reference to the detection pattern 710 based on the density value Dpk generally equal to the reference density value Drf (to be precise, the density value Dpk that is equal to the reference density value Drf within a predetermined error range, which is Dp3 in the example shown in (A) and (B) of FIG. 33) among the detection pattern density values Dp1 to Dp6. Accordingly, the measurement position adjustment process of the present embodiment can be implemented using the measurement position detection chart 71 shown in (A) of FIG. 33, instead of the measurement position detection chart 71 shown in (A) of FIG. 10, in the measurement position adjustment process of the first embodiment outlined in FIG. 9. Thus, the present embodiment can also ensure effects similar to those achieved in the first embodiment.

It should be noted that in the present embodiment, depending on the width of the linear pattern 712, which extends obliquely relative to the conveyance direction, within the measurement position detection chart 71 shown in (A) of FIG. 33 and the intervals of the measurement positions in the conveyance direction (i.e., the intervals of the conveyance direction positions pi and pi+1), none or two of the detection pattern density values, such as those denoted by Dp1, Dp2, Dp3, etc., in the colorimetric data obtained by the colorimeter 64 might be generally equal to the reference density value Drf (i.e., equal to the reference density value Drf within the predetermined error range). Therefore, given this point, the measurement position adjustment process of the present embodiment may be implemented using the measurement position detection chart 71 shown in (A) of FIG. 33, instead of the measurement position detection chart 71 shown in (A) of FIG. 23, in the measurement position adjustment process of the seventh embodiment outlined in FIG. 24.

### 11. Variants

The present invention is not limited to the above embodiments, and further, numerous variations can be made without departing from the scope of the invention.

While in the embodiments, the present invention is applied to the inkjet printing devices, the invention can also be applied to other printing devices, for example, those not of the inkjet type, by appropriately modifying the configurations of the embodiments as necessary.

While the embodiments and their variants have been described for the purpose of disclosing the present invention, the foregoing description is illustrative in all aspects and not restrictive. It is understood that numerous other modifications and variations can be devised without departing from the scope of the invention. Moreover, the scope of the invention encompasses features of the embodiments and variants appropriately combined without deviating from the spirit of the invention or introducing contradictions.

### 12. Other

This application claims priority based on Japanese Patent Application No. 2023-050870 filed on Mar. 28, 2023 and entitled “Printing Device, Color Measurement Position Detection Method, and Color Measurement Position Detection Program”, the disclosure of which is incorporated herein by reference.

What is claimed is:

1. A printing device for recording a color image on a printing medium, comprising:
a conveyance mechanism configured to convey the printing medium in a first direction;
a printhead configured to record the color image on the printing medium;
a reader configured to perform color measurements on a color chart by reading the color chart at a reading spot of a predetermined size, the color chart being recorded on the printing medium by the printhead and including a plurality of color patches arranged in the first direction; and
a control portion configured to control the conveyance mechanism, the printhead, and the reader, wherein,
the control portion executes:
an image printing process for controlling the conveyance mechanism and the printhead to record the color chart on the printing medium along with the color image serving as a printing target;
a position detection chart printing process for controlling the conveyance mechanism and the printhead to record a position detection chart on the printing medium to detect a position of the reading spot where the color chart is read, the position detection chart being recorded at a position corresponding to a position of the color chart on the printing medium in a second direction perpendicular to the first direction and parallel to the printing medium;
a position detection chart reading process for controlling the conveyance mechanism and the reader such that the reader reads the position detection chart recorded on the printing medium; and
a position detection process for detecting, as a current measurement position, a position of the reading spot in the second direction relative to the position detection chart recorded on the printing medium, based on read data obtained by the reader in the position detection chart reading process, and
the position detection chart includes:
a reference pattern with a larger dimension in the second direction than a dimension of the reading spot in the second direction; and
a detection pattern including within a range defined by the reference pattern in the second direction, either a plurality of patches arranged in the first direction while sequentially deviating from one another in the second direction or a linear pattern with a predetermined width extending obliquely relative to the first direction.

2. The printing device according to claim 1, wherein,
in the second direction, each of the plurality of patches has a dimension greater than or equal to the dimension of the reading spot but less than the dimension of the reference pattern, and
in the second direction, the width of the linear pattern is greater than or equal to the dimension of the reading spot but less than the dimension of the reference pattern.

3. The printing device according to claim 1, wherein the control portion determines the current measurement position based on a position in the second direction within the detection pattern after identifying:
data for the detection pattern equal to data for the reference pattern within a predetermined error range among the read data obtained by the reader in the position detection chart reading process;
a position in the first direction within the detection pattern where the reader outputted the identified data; and
the position in the second direction within the detection pattern corresponding to the identified position in the first direction.

4. The printing device according to claim 1, wherein, the detection pattern includes of the plurality of patches,
the reference pattern and the plurality of patches have the same color,
the reader is a colorimeter,
in the position detection chart reading process, the control portion controls the conveyance mechanism and the colorimeter such that the colorimeter obtains colorimetric values including a reference measurement value for the reference pattern and detection pattern measurement values for a plurality of positions in the first direction respectively corresponding to the plurality of patches, and
in the position detection process, the control portion detects, as the current measurement position, the position of the reading spot in the second direction relative to the position detection chart recorded on the printing medium, based on the reference measurement value and the detection pattern measurement values.

5. The printing device according to claim 4, wherein, when any of the detection pattern measurement values obtained in the position detection chart reading process is equal to the reference measurement value within a predetermined error range, the control portion detects, as the current measurement position, a position in the second direction for one of the plurality of patches at a position in the first direction corresponding to the generally equal detection pattern measurement value in the position detection process.

6. The printing device according to claim 4, wherein,
when none of the detection pattern measurement values obtained in the position detection chart reading process are equal to the reference measurement value within a predetermined error range, the control portion performs a new position detection chart printing process to control the conveyance mechanism and the printhead to record a new position detection chart on the printing medium, the new position detection chart including a new reference pattern of the same size as the reference pattern and a new detection pattern with a new set of patches arranged in the first direction while sequentially deviating from one another in the second direction by a smaller amount than among the plurality of patches,
the control portion then performs a new position detection chart reading process to control the conveyance mechanism and the colorimeter such that the colorimeter obtains colorimetric values for the new position detection chart recorded on the printing medium in the new position detection chart printing process, the colorimetric values including a new reference measurement value for the new reference pattern and new detection pattern measurement values for a plurality of positions in the first direction respectively corresponding to the new set of patches, and
the control portion determines the current measurement position based on the new reference measurement value and the new detection pattern measurement values obtained in the new position detection chart reading process.

7. The printing device according to claim 4, wherein,
when none of the detection pattern measurement values obtained in the position detection chart reading process are equal to the reference measurement value within a predetermined error range, and the closest of the detection pattern measurement values to the reference measurement value differs from the reference measurement value by more than a predetermined tolerance value, or when the detection pattern measurement values include more than one maximal or minimal values across positional variations along the first direction, the control portion performs a maintenance process to maintain a function of recording an image on the printing medium using the conveyance mechanism and the printhead, and
after the maintenance process, the control portion sequentially performs the position detection chart printing process and the position detection chart reading process again to determine the current measurement position based on a new reference measurement value and new detection pattern density values obtained in the new position detection chart reading process.

8. The printing device according to claim 4, wherein,
the plurality of patches are provided as at least two patch arrays, each consisting of a set of patches arranged in the first direction while sequentially deviating from one another in the second direction within the range defined by the reference pattern in the second direction,
the at least two patch arrays differ in patch dimension in the second direction, and
the control portion identifies a value equal to the reference measurement value within a predetermined error range from among the detection pattern measurement values obtained in the position detection chart reading process, and determines, as an appropriate patch dimension, a dimension of one of the plurality of patches at a position in the first direction corresponding to the equal detection pattern measurement value.

9. The printing device according to claim 4, wherein, when more than one of the detection pattern measurement values obtained in the position detection chart reading process are equal to the reference measurement value within a predetermined error range, the control portion determines the current measurement position in the position detection process with reference to the detection pattern based on a middle position among a plurality of positions in the first direction corresponding to the equal detection pattern measurement values.

10. The printing device according to claim 4, wherein,
when more than one of the detection pattern measurement values obtained in the position detection chart reading process are equal to the reference measurement value within a predetermined error range, the control portion controls the conveyance mechanism and the printhead to record a new position detection chart on the printing medium, the new position detection chart including a new reference pattern of the same size as the reference pattern and a new detection pattern with a new set of patches arranged in the first direction while sequentially deviating from one another in the second direction, the new set of patches each having a smaller dimension in the second direction than a dimension of each of the plurality of patches in the second direction,
the control portion controls the conveyance mechanism and the colorimeter such that the conveyance mechanism conveys the printing medium in the first direction and the colorimeter obtains colorimetric values for the new position detection chart recorded on the printing medium, the obtained colorimetric values including a new reference measurement value for the new reference pattern and new detection pattern measurement values for a plurality of positions in the first direction respectively corresponding to the new set of patches, and
the control portion determines the current measurement position based on the new reference measurement value and the new detection pattern measurement values.

11. The printing device according to claim 4, wherein, when none of the detection pattern measurement values obtained in the position detection chart reading process are equal to the reference measurement value within a predetermined error range, the control portion determines the current measurement position based on a first direction detection position with reference to the detection pattern, the first direction detection position representing a position in the first direction corresponding to the current measurement position by means of the detection pattern and being calculated through interpolation based on at least two closest of the detection pattern measurement values to the reference measurement value.

12. The printing device according to claim 4, wherein,
the reference pattern consists of a predetermined number of subpatterns in different colors arranged in the first direction, with the predetermined number being three or more and each subpattern having the same dimension in the second direction as the reference pattern,
each of the plurality of patches consists of subpatches whose number is the same as the subpatterns, with the subpatches being arranged in the first direction respectively corresponding to the subpatterns and having the same colors as the respectively corresponding subpatterns,
the reference pattern consisting of the predetermined number of sub-patterns and each patch consisting of the predetermined number of sub-patches are regarded as having the same color, and
when the colorimetric values obtained by the colorimeter in the position detection chart reading process include colorimetric values for the subpatterns within the reference pattern and colorimetric values for positions in the first direction corresponding to the subpatches within the plurality of patches, if the colorimetric values for positions in the first direction corresponding to at least two of the subpatches within one of the plurality of patches are equal within a predetermined error range to the colorimetric values for at least two subpatterns within the reference pattern respectively corresponding to the at least two of the subpatches, the control portion regards that all colorimetric values for all positions in the first direction corresponding to the one of the plurality of patches are equal within the predetermined error range to all the colorimetric values for the reference pattern.

13. The printing device according to claim 4, wherein,
the plurality of patches are provided as at least two patch arrays, each consisting of a set of patches arranged in the first direction while sequentially deviating from one another in the second direction within the range defined by the reference pattern in the second direction,
the at least two patch arrays have the same patch size,
the set of patches in each of the at least two patch arrays respectively correspond to the set of patches in another or the other of the at least two patch arrays, with groups of corresponding patches between or among the at least two patch arrays sharing the same positions in the second direction, and
the control portion performs an anti-meandering process to compare the corresponding patches between or among the groups in terms of detection pattern measurement values for their respective positions in the first direction within the detection pattern measurement values obtained in the position detection chart reading process, acquires information regarding whether the compared patches exhibit differences in the detection pattern measurement values exceeding a predetermined tolerance value, and determines whether the printing medium is meandering based on the acquired information.

14. The printing device according to claim 4, wherein,
the plurality of patches are provided as at least two patch arrays, each consisting of a set of patches arranged in the first direction while sequentially deviating from one another in the second direction within the range defined by the reference pattern in the second direction,
the at least two patch arrays have the same patch size,
the set of patches in each of the at least two patch arrays respectively corresponds to the set of patches in another or the other of the at least two patch arrays, with groups of corresponding patches between or among the at least two patch arrays sharing the same positions in the second direction, and
the control portion compares the corresponding patches between or among the groups in terms of detection pattern measurement values for their respective positions in the first direction within the detection pattern measurement values obtained in the position detection chart reading process, determines, among the groups of corresponding patches compared in terms of the detection pattern measurement values, the number of groups for which the detection pattern measurement values are equal to the reference measurement value within a predetermined error range, and identifies a meandering amount of the printing medium based on the determined number.

15. The printing device according to claim 1, wherein,
the detection pattern consists of the linear pattern with the predetermined width,
the reference pattern and the linear pattern have the same color,
the reader is a colorimeter;
in the position detection chart reading process, the control portion controls the conveyance mechanism and the colorimeter such that the colorimeter obtains colorimetric values including a reference measurement value for the reference pattern and detection pattern measurement values for a plurality of positions situated at predetermined intervals in the first direction within a range defined by the linear pattern in the first direction, and
in the position detection process, the control portion detects, as the current measurement position, the position of the reading spot in the second direction relative to the position detection chart recorded on the printing medium, based on the reference measurement value and the detection pattern measurement values.

16. The printing device according to claim 1, further comprising a moving mechanism configured to move the reader in the second direction, wherein,
the control portion determines a deviation amount from an appropriate position of the reading spot in the second direction where the color chart is read, based on the current measurement position detected in the position detection process, and controls the moving mechanism based on the deviation amount to place the reading spot at the appropriate position in the second direction.

17. The printing device according to claim 1, further comprising:
an imaging device configured to capture an image recorded on the printing medium; and
a moving mechanism configured to move the reader in the second direction, wherein,
when the printing medium is replaced, the control portion executes the following processes before the image printing process and the position detection chart printing process:
an initial position detection chart printing process for controlling the recording portion and the conveyance mechanism to record a previously prepared initial position detection chart on the printing medium;
an initial position detection chart capturing process for controlling the imaging device and the conveyance mechanism such that the imaging device captures the initial position detection chart recorded on the printing medium;
an initial position determination process for determining a position in which to dispose the colorimeter, based on captured image data obtained by the imaging portion in the initial position detection chart capturing process; and
a colorimeter moving process for controlling the moving mechanism to move the colorimeter to the position determined in the initial position determination process.

18. A color measurement position detection method for detecting, as a measurement position, a position of a reading spot where a reader of a printing device that records a color image on a printing medium reads a color chart recorded on the printing medium, wherein,
the printing device includes:
a conveyance mechanism configured to convey the printing medium in a first direction;
a printhead configured to record the color image on the printing medium; and
the reader,
the reader performs color measurements on the color chart by reading the color chart at the reading spot after the printhead records the color chart on the printing medium with a plurality of color patches arranged in the first direction,
the method comprises:
an image printing step of causing the conveyance mechanism and the printhead to record the color chart on the printing medium along with the color image serving as a printing target;
a position detection chart printing step of causing the conveyance mechanism and the printhead to record a position detection chart on the printing medium to detect the position of the reading spot where the color chart is read, with the position detection chart being recorded at a position corresponding to a position of the color chart on the printing medium in a second direction perpendicular to the first direction and parallel to the printing medium;
a position detection chart reading step of causing the reader to read the position detection chart recorded on the printing medium; and
a position detection step for detecting, as a current measurement position, a position of the reading spot in the second direction relative to the position detection chart recorded on the printing medium based on read data obtained by the reader in the position detection chart reading step, and
the position detection chart includes:
a reference pattern with a larger dimension in the second direction than a dimension of the reading spot in the second direction; and
a detection pattern including within a range defined by the reference pattern in the second direction, either a plurality of patches arranged in the first direction while sequentially deviating from one another in the second direction or a linear pattern with a predetermined width extending obliquely relative to the first direction.

19. The color measurement position detection method according to claim 18, wherein,
the detection pattern includes the plurality of patches,
the reference pattern and the plurality of patches have the same color,
the reader is a colorimeter;
in the position detection chart reading step, the colorimeter obtains colorimetric values consisting of a reference measurement value for the reference pattern and detection pattern measurement values for a plurality of positions in the first direction respectively corresponding to the plurality of patches, and
in the position detection step, the current measurement position is detected based on the reference measurement value and the detection pattern measurement values.

20. A non-transitory computer-readable recording medium containing a color measurement position detection program for detecting, as a measurement position, a position of a reading spot where a reader of a printing device that records a color image on a printing medium reads a color chart recorded on the printing medium, wherein,
the printing device includes:
a conveyance mechanism configured to convey the printing medium in a first direction;
a printhead configured to record the color image on the printing medium; and
the reader,
the reader performs color measurements on the color chart by reading the color chart at the reading spot after the printhead records the color chart on the printing medium with a plurality of color patches arranged in the first direction,
the measurement position detection program causes a computer included in the printing device to execute:
an image printing step of causing the conveyance mechanism and the printhead to record the color chart on the printing medium along with the color image serving as a printing target;
a position detection chart printing step of causing the conveyance mechanism and the printhead to record a position detection chart on the printing medium to detect the position of the reading spot where the color chart is read, with the position detection chart being recorded at a position corresponding to a position of the color chart on the printing medium in a second direction perpendicular to the first direction and parallel to the printing medium;
a position detection chart reading step of causing the reader to read the position detection chart recorded on the printing medium; and
a position detection step for detecting, as a current measurement position, a position of the reading spot in the second direction relative to the position detection chart recorded on the printing medium based on read data obtained by the reader in the position detection chart reading step, and
the position detection chart includes:
a reference pattern with a larger dimension in the second direction than a dimension of the reading spot in the second direction; and
a detection pattern including within a range defined by the reference pattern in the second direction, either a plurality of patches arranged in the first direction while sequentially deviating from one another in the second direction or a linear pattern with a predetermined width extending obliquely relative to the first direction.
